(19) United States
(12) Patent Application Publication
(10) Pub. No.: US 2026/0218025 A1
(43) Pub. Date: Jul. 30, 2026

(54) A BIO-PRESERVATION STICKER, METHODS OF PRODUCING THE SAME AND USES THEREOF

(71) Applicant: LIVA BIO PROTECTION TECHNOLOGIES LTD., Rehovot (IL)

(72) Inventor: Ifat HAMMER, Rehovot (IL)

(73) Assignee: LIVA BIO PROTECTION TECHNOLOGIES LTD., Rehovot (IL)

(21) Appl. No.: 19/148,529

(22) PCT Filed: Jan. 17, 2024
(86) PCT No.: PCT/IL2024/050070

§ 371 Date: Jul. 16, 2025

Related U.S. Application Data
(60) Provisional application No. 63/439,361, filed on Jan. 17, 2023.

(51) Int. Cl. C09J 189/00; A01N 25/24

(52) U.S. Cl. CPC C09J 189/00; A01N 25/24; C09J 2301/41

(57) ABSTRACT

A sticker comprising at least one adhesive component comprising a carrier composition holding a nutrient composition; wherein said carrier composition comprises a food grade binder and said nutrient composition comprises at least one compound suitable for supporting selective growth of one or more human safe bacterium.

### TECHNOLOGICAL FIELD

The present disclosure relates to methods and devices for the preservation of food and agricultural produce, and other consumer goods.

### BACKGROUND ART

References considered to be relevant as background to the presently disclosed subject matter are listed below:
International Patent Application Publication No. WO2021/033190

Acknowledgement of the above references herein is not to be inferred as meaning that these are in any way relevant to the patentability of the presently disclosed subject matter.

### BACKGROUND

The food industry is in constant search for safe methods for preserving food and agricultural produce.

WO2021/033190 describes protection inserts comprising a discrete substrate-forming material holding a nutrient composition, the nutrient composition comprising a combination of nutrients for supporting selective growth of one or more bacteriocin-producing bacterium on said substrate and being essentially free of externally added microorganisms. The protection inserts can be included in a consumer goods package comprising goods to be protected and can be held within a carrier.

### GENERAL DESCRIPTION

The present disclosure is based on the development of a preservation sticker for increasing a shelf-life of consumer goods, fresh food products and agricultural produce by stimulating growth of selected bacteria within packages containing the goods, without the use of externally added live bacteria to the consumer goods, and thereby eliminating difficulties and costs associated with use of living bacteria in industrial plants.

There is thus provided, according to a first aspect of the presently disclosed subject matter, a sticker comprising at least one adhesive component comprising a carrier composition holding a nutrient composition; wherein said carrier composition comprises a food grade binder and said nutrient composition comprises at least one compound suitable for supporting selective growth of one or more human safe bacterium.

According to a second aspect of the presently disclosed subject matter, there is provided a consumer goods or to consumer goods package and a sticker of the first aspect of the presently disclosed subject matter, adhered to the consumer goods or to a packaging element holding the goods.

According to a third aspect of the presently disclosed subject matter, there is provided a method for preserving consumer goods, the method comprises adhering to a package holding said consumer goods a sticker of the first aspect of the presently disclosed subject matter, said adhering is in a manner allowing moisture passageway between said consumer goods and said adhesive component.

According to a fourth aspect of the presently disclosed subject matter, there is provided a method for manufacturing a food safe sticker, the method comprising mixing a carrier composition comprising a food grade binder with a nutrient composition comprising at least one compound suitable for supporting selective growth of one or more human safe bacterium to form an adhesive component and shaping said adhesive component.

Finally, according to a fifth aspect of the presently disclosed subject matter, there is provided a method for manufacturing a food safe sticker, the method comprises providing an adhesive component comprising a carrier composition holding a nutrient composition; wherein said carrier composition comprises a food grade binder and said nutrient composition comprises at least one compound suitable for supporting selective growth of one or more human safe bacterium; and disposing onto at least one side of said adhesive component at least one of a first backing material and a first removable liner and optionally onto an opposite second side of said adhesive component at least one of a second backing material and second removable liner, said first backing material and said second backing material can be the same or different and said first removable liner and said second removable liner can be the same or different.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1Q are schematic illustrations of a sticker according to some examples of the presently disclosed subject matter.

FIG. 2A-2E are schematic illustrations of a consumer goods package according to some examples of the presently disclosed subject matter.

FIGS. 3A-3C illustrate a sticker adhered to a bread package according to an example of the presently disclosed subject matter, at day zero (FIG. 3A), after 13 days (FIG. 3B) and after 20 days (FIG. 3C).

FIGS. 4A-4C illustrate a sticker adhered to a cake package according to an example of the presently disclosed subject matter, at day zero (FIG. 4A), after 10 days (FIG. 4B) and after 25 days (FIG. 4C).

FIG. 5 is a bar graph showing mold count results from a trial, identified as Str. 1 and conducted at 13° C., 75% RH.

FIGS. 6A-6D are representative images of mold count plates from trial Str. 1 after 7 days of follow up demonstrating microbiome differences in treatment as compared to control and the reduction in mold colonies including: control total count (FIG. 6A), control yeast and mold (FIG. 6B), experimental total count (FIG. 6C) and experimental yeast and mold (FIG. 6D).

FIGS. 7A-7D are representative images of strawberries in a pack of trial Str. 2 after 7 days storage at 13° C. and 75% RH including Control group at T0 (FIG. 7A) and at T7 (FIG. 7B) and Experimental group at T0 (FIG. 7C) and at T7 (FIG. 7D).

FIGS. 8A-8D are representative images of strawberries in a pack of trial Str. 3 after storage at ambient room temperatures including Control group at T0 (FIG. 8A) and at T3 (FIG. 8B) and Experimental group at T0 (FIG. 8C) and at T3 (FIG. 8D).

FIGS. 9A-9D are representative images of strawberries in a pack of trial Str. 5A after storage at 4° C./75-90% RH for 5 days followed by 4 days of storage in 13° C./75% RH including Control group at T0 (FIG. 9A) and at T9 (FIG. 9B) and Experimental group at T0 (FIG. 9C) and at T9 (FIG. 9D).

FIGS. 10A-10D are representative images of strawberries in a pack of trial Str. 5B after storage at 4° C./75-90% RH for 5 days followed by 7 days of storage in 13° C./75% RH including Control group at T0 (FIG. 10A) and at T12 (FIG. 10B) and Experimental group at T0 (FIG. 10C) and at T12 (FIG. 10D).

FIGS. 11A-11D are representative images of strawberries in a pack of trial Str. 5C after storage at 4° C./75-90% RH for 5 days followed by 8 days of storage in 13° C./75% RH including Control group at T0 (FIG. 11A) and at T13 (FIG. 11B) and Experimental group at T0 (FIG. 11C) and at T13 (FIG. 11D).

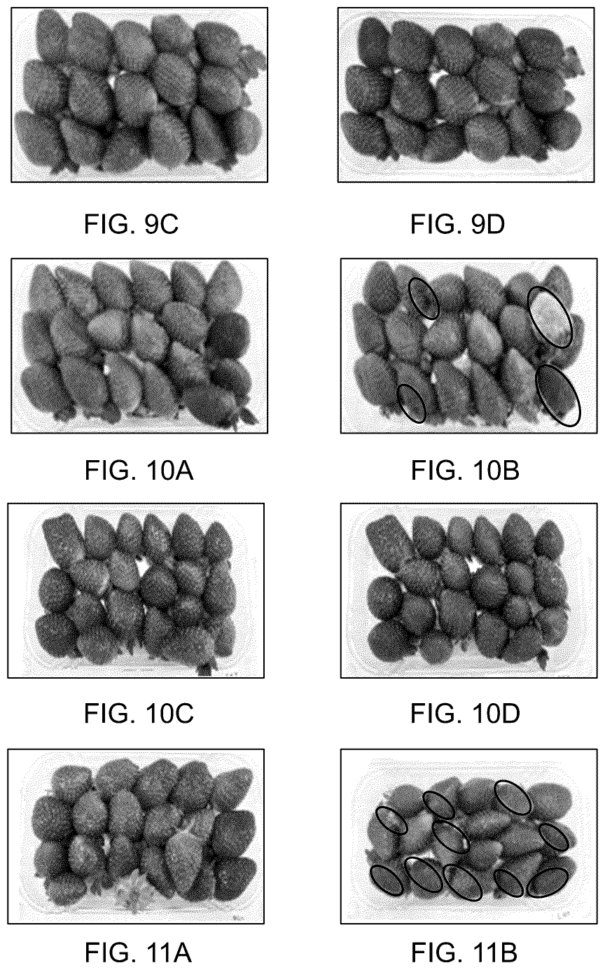

FIG. 12 is a bar graph showing mold count results from a trial, identified as Tmt. 1 and conducted at 13° C., 75% RH.

FIG. 13A-13D are representative images of mold count plates from trial Tmt. 1 after 6 days of follow up demonstrating microbiome differences in treatment as compared to Control and the reduction in mold colonies including: control total count (FIG. 9A), control yeast and mold (FIG. 9B), Experimental total count (FIG. 9C) and experimental yeast and mold (FIG. 9D).

FIG. 14 is a bar graph showing mold count results from a trial, identified as Tmt.3 and conducted at 13° C., 75% RH.

FIGS. 15A-15D are representative images of mold count plates from trial Tmt.3 after 7 days of follow up demonstrating microbiome differences in treatment as compared to Control and the reduction in mold colonies including: control total count (FIG. 15A), control yeast and mold (FIG. 15B), Experimental total count (FIG. 15C) and experimental yeast and mold (FIG. 15D).

FIGS. 16A-16B includes images of mangoes showing the results in duplicates of shelf-life study on sticker protected mangoes including a Control group (FIG. 16A) compared to an Experimental group (FIG. 16B) during 5, 7 and 10 days of follow up.

### DETAILED DESCRIPTION

The presently disclosed subject matter relates to a preservation sticker for increasing a shelf-life of consumer goods, such as fresh food products and agricultural produce by stimulating growth of selected bacteria within packages containing the goods, without the use of externally added live bacteria to the consumer goods, and thereby eliminating difficulties and costs associated with use of living bacteria in industrial plants.

In the context of the present disclosure, a food preservation sticker or a preservation sticker or a sticker denotes a unit form that is used to preserve consumer goods from spoiling as a result of microbial growth of pathogenic and undesired microorganisms on the goods. The goods may be any edible material, including industrially produced food stuff, fresh produce, crops etc., as well as non-edible goods, that have a tendency to spoil/rotten, such as cosmetics, home care products and drugs.

All the above is collectively being referred to herein as “goods”.

The preservation sticker is designed such to selectively support the growth of human friendly bacterium that is naturally present in the environment (in the air, i.e. airborne bacteria, in the soil, on the goods itself). Without being bound by theory, it is believed that such bacterium, selectively grown on the sticker, and its spread inside on or in the surrounding of the goods (either through water vapors or biofilm formation) allows for the preservation by competing with spoiling or pathogenic bacteria and secreting antimicrobial bacteriocins.

In some examples, the preservation sticker can be utilized for preventing growth of pathogenic microorganism and/or spoilage microorganism in packed goods, thereby increasing the shelf-life of the goods.

In some examples, the preservation sticker disclosed herein extends the shelf life of a good by at least 10%, at times, by at least 20%, at times by at least 30%, at times by at least 50%, at times by at least 60%, at times by at least 70%, at times by at least 80%, at times by at least 90%, at times by even 100% as compared to the shelf life of the same goods package stored under the same conditions, without the preservation sticker.

Accordingly, the presently disclosed subject matter provides a sticker comprising at least one adhesive component comprising a carrier composition holding a nutrient composition; wherein said carrier composition comprises a food grade binder and said nutrient composition comprises at least one compound suitable for supporting selective growth of one or more human safe bacterium.

In the context of the present disclosure when referring to a “sticker” is to be understood to mean a material with an adhesive layer configured to adhere to a designated surface. In some examples the sticker is in the form of a roll. In some examples the sticker is in the form of separate pre-cut sheets. In some examples the pre-cut sheets have a geometrical shape e.g. rectangular, triangular, polygonal, circular, oval, etc.

In the context of the present disclosure when referring to an “adhesive layer” “adhesive composition” “adhesive component” or “adhesive” it is to be understood to mean a compound or a composition which is configured to form a bond when adhered to a designated surface.

In some examples, the adhesive component of the presently disclosed subject matter is configured to support a selective growth of one or more human safe bacterium and is essentially free of externally added microorganisms. For instance, the adhesive component comprises a carrier composition holding a nutrient composition with a food grade binder. The nutrient composition comprises at least one compound or a combination of nutrients for supporting selective growth of the human safe bacterium while inhibiting or preventing growth of undesired microorganisms. In other words, in the presence of the selective nutrients, predominantly only the desired human safe bacterium is effectively grown, and the proliferation of the human safe bacteria suffices for preventing undesired growth of spoilage microorganisms.

In the context of the present disclosure, when referring to selectively promote growth of the human safe bacterium it is to be understood to predominantly allow growth of only the target bacterium, e.g. bacteriocin producing bacterium, without a detectable amount or with less than 100 CFU/gr growth, or less than 10 CFU/cm² of other microorganisms, such as yeast, enterococcus bacteria etc.

In this context, the detectable amount of the selectively grown bacterium would be, in the presence of the presently disclosed device with the selective nutrient composition, more than 10 CFU/gr, or at least more than 10², as can be measured using the microbial total count test, also known as the total viable count or total plate count. This method is used to estimate the total number of viable microorganisms in a sample. There are several official and widely accepted methods for conducting microbial total count testing. One of the most commonly used methods is the pour plate method using Nutrient Agar or Standard Methods Agar as described in ISO 4833.

The practice of constructing nutrient compositions that are selective in supporting growth of a particular target microorganism is known from diagnostic microbiology. For example, and without being limited thereto, Bonnet et al. demonstrates the selective culturing of target microorganism [M Bonnet et al. “Bacterial culture through selective and none-selective conditions: the evaluation of culture media in clinical microbiology” New Microbe and New Infect 2020; 34: 100622]. Further, as a non-limiting example, MRS culture media is known to be selective for the growth of lactic acid bacteria. Further exemplary art includes, Nwadiuto O. Nwamaioha and Salam A. Ibrahim “A selective medium for the enumeration and differentiation of Lactobacillus delbrueckii ssp. bulgaricus” J. Dairy Sci. 101:4953-4961.

In the context of the presently disclosed subject matter, the term “selective growth” is to be understood to signify the promotion of growth exclusively of target bacteriocin-producing/human safe bacteria while inhibiting growth of other spoilage bacteria or pathogens.

In the context of the present disclosure, a “human safe bacterium” refers to any Generally Recognized As Safe Bacteria which is permitted for use for human consumption by global regulations and has a long history of use in traditional foods.

In some examples, the human safe bacterium comprises lactic acid bacteria (LAB). Such bacteria are known to have the ability to inhibit growth of undesired microorganism, including, inter alia, spoilage microorganisms and pathogenic bacteria. This inhibitory activity is the result of the metabolic products secreted by these LAB which act as antimicrobial compounds. These compounds include organic acids, diacetyl, hydrogen peroxide and bacteriocin.

The sticker disclosed herein can support the growth of various LAB. Examples of LAB include Lactobacillus Plantarum, Lactobacillus Lactis, Lactobacillus Brevis.

In some other examples, the sticker disclosed herein can support the growth of bacteria other than LAB such as Bacillus species. These include, without being limited thereto, Bacillus subtillis, Bacillus pumilis, Bacillus safensis, Bacillus thuringiensis, Bacillus amyloliquefaciens, Bacillus lichenformis, Bacillus megaterium, Bacillus coagulans, and Bacillus brevis.

In some examples of the presently disclosed subject matter, the human safe bacterium comprises probiotic bacterium. The nutrient composition held by the carrier device comprises different types of substances, each acting as a source for a different nutrient element required for the growth to the human-safe (e.g. bacteriocin producing) bacterium.

Without being bound to theory, the selective growth is achieved by providing the specific nutritional requirements (namely, the nutrient composition disclosed herein) specific for the desired bacteria along with generating conditions which inhibit the growth of other undesired microorganisms. Such conditions include, for example, any one or combination of preservatives, pH control agents, oxygen control and temperature control.

In some examples, the selective growth can be supported or achieved by any one or combination of controlling the oxygen level, e.g. by monitoring or specifically designing the permeability of the package holding the goods, by controlling the storage temperature, by controlling pH using specifically selected pH adjusting agents etc.

The ratio between the different components of the sticker may vary depending on the good to be preserved, the conditions of storage (temperature, humidity etc) and the type of human safe microorganism, the stimulation of which is desired.

In the context of the present disclosure when referring to “essentially free of externally added microorganisms” it is to be understood that no microorganisms were added to the sticker and the microorganisms found on the sticker are only those grown during preservation period.

In the context of the present disclosure, when referring to spoilage microorganism it is to be understood as encompassing microorganism that cause undesirable changes to the quality of goods (cause goods, such as food, to deteriorate and develop unpleasant odors, tastes, and textures, e.g. cause fruits and vegetables to get mushy or slimy, or meat to develop a bad odor) but are not toxic to consume. The spoilage microorganism typically metabolizes gases, acids, sulfur compounds and nitrogen compounds that impact on the sensorial properties of the goods, specifically when referring to food stuff.

When referring to pathogenic microorganism it is to be understood as encompassing microorganism that are harmful to consume, or they produce toxins that are harmful or fatal if consumed. Some non-limiting examples of pathogenic microorganism include Campylobacter, Salmonella, E. coli, Clostridium perfringens, Bacillus cereus, Listeria monocytogenes, Shigella spp., Staphylococcus aureus, Streptococcus and Vibrio bacteria.

In some examples, the carrier composition comprises a food grade hygroscopic agent.

In the context of present invention, the term “hygroscopic material” or “hygroscopic agent” denotes a material readily absorbing moisture from the atmosphere. It is noted that the adhesive component can be in a solid, semi solid or highly viscous form. When exposed to ambient atmosphere, the adhesive composition absorbs substantial amounts of moisture. Without being bound by a theory, it is presently believed that moisture absorption activates the adhesive composition thus enabling said composition to support the growth of human friendly bacterium.

In some examples, the hygroscopic material is any one or combination of polyols, polysaccharides, salts and silicon compounds.

Non-limiting examples of hygroscopic polyols include glycerin, sorbitol, propylene glycol, lactitol, xylitol, erythritol, isomalt, mannitol, maltitol, and any combination of same.

In some examples the hygroscopic polysaccharides include without being limited thereto maltodextrin, dextrin, polydextrose, and any combination of same.

In some examples the hygroscopic salts include without being limited thereto potassium gluconate, calcium gluconate, sodium gluconate, potassium acetate, sodium acetate, calcium acetate, sodium lactate, sodium citrate, potassium citrate, calcium citrate, sodium maleate, potassium maleate, calcium maleate, potassium aluminum silicate, aluminum silicate, calcium glutamate, monoammonium glutamate, magnesium diglutamate, sodium acetate, sodium chloride, calcium chloride, and any combination of same.

In some examples, the hygroscopic silicon compounds include silica, calcium silicate, sodium silica aluminate and magnesium silicate.

In some examples, the hygroscopic compound comprises at least sodium chloride.

In some examples, the hygroscopic compound comprises at least glycerol.

In some examples, the hygroscopic compound comprises a combination of sodium chloride and glycerol.

In some examples, the amount of hygroscopic compound, be it a single hygroscopic compound or a combination of several such additives, is within the range of 1% and 15% out of the total weight of the adhesive component, at times between 1.5% and 3%, at times between 2% and 5% and times between 4% and 8%, at times between 6% and 12%, at times between 10% and 15%, or any other range within the range of 1% and 15%.

In some examples the food-grade binder of the carrier composition is selected from a group comprising polysaccharides, proteinaceous materials, waxes, or combinations thereof.

Notably, in the context of the present disclosure the term “food grade” denotes any material that is acceptable and approved for human consumption.

In some examples the polysaccharide is selected from the group consisting of starch, modified starch, algin, pectin, carrageenan, locust been gum, guar gum, xanthan gum, dextrin, agarose, agar-agar, pullulan, cellulose, sodium carboxymethyl cellulose, hydroxypropyl cellulose, hydroxypropyl methyl cellulose, methyl cellulose, sodium alginate, potassium alginate, ammonium alginate, calcium alginate, propane-1,2 diol alginate, tragacanth, chitosan, acacia (gum arabic), karaya gum, tara gum, gellan gum and any combination of same.

In some examples the protein or proteinaceous material is selected from the group consisting of gelatin, soy hydrolysate, casein, whey protein, pea protein, mung bean protein and soy protein.

In some examples, the protein or proteinaceous material is selected from the group consisting of animal derived protein, plant derived protein, insect-derived protein, algae derived protein and any combination of same.

In some examples, the protein or proteinaceous material is selected from the group consisting of rice, maize, wheat, barley, oat, sorghum, buckwheat, amaranth, quinoa, peas, chickpeas, lentils, lupin, flaxseed, soybean, peanuts, sunflower, cotton, hempseed, sesame, chia, pumpkin, almonds, chestnuts, pecans, walnuts, gelatin, casein, whey egg albumen protein, beef protein, bovine protein and any combination of same.

In some examples the wax is selected from the group consisting of beeswax, carnauba wax, candelilla wax, soy wax, shellac, microcrystalline wax and any combination of same.

In some examples, the amount of binder is between about 40% and about 70% out of the total weight of the adhesive component, at times, between about 50% and about 65%, at times, between about 55% and about 65%, and at times, between about 65% and about 70%, or any other range within the range of about 50% and about 70%.

In some examples, the food grade binder comprises dextrin. The dextrin is in an amount of between about 40 wt % and about 70 wt % out of a total weight of the adhesive component, preferably between about 55 wt % and about 65 wt % out of a total weight of the adhesive component.

In some examples, the food grade hygroscopic agent comprises at least one salt. The salt can be sodium chloride in an amount of between about 1 wt % and 15 wt % out of a total weight of the adhesive component, preferably between about 2 wt % and 10 wt % out of a total weight of the adhesive component.

In some examples, the carrier composition can comprise different types of substances (nutrient composition), each acting as a source for a different nutrient element required for the growth to the human safe bacterium. The nutrient composition is blended within the carrier composition.

In some examples, the nutrient composition comprises a combination of compounds selected from the group consisting of nitrogen containing compounds, carbohydrates, inorganic minerals, inorganic salts, fatty acids, and vitamins.

In some examples, the at least one nitrogen containing compound is selected from the group consisting of at least one amino acid, at least one peptide, at least one polypeptide, at least one protein hydrolysate. These may be obtained from various sources.

In some examples, the source for the nitrogen containing compounds is an animal source, such as beef extract and/or casein hydrolysate.

In some examples, the source for the nitrogen containing compounds is a microorganism extract, such as yeast extract.

In some examples, the source for the nitrogen containing compounds is a plant extract, such as a legume extract. In this context, the legume may be any type of legume, such as, without being limited thereto, peas, chickpeas, potato, soy, beans, and others.

In some examples, the nitrogen containing compound comprises a combination of one or more extracts and one or more hydrolysates from different sources.

In some examples, the nitrogen containing compound comprises at least a protein hydrolysate, at times peptone and at times preferably soy peptone.

In some examples, the nitrogen containing source comprises at least yeast extract.

In some examples, the nitrogen containing source comprises at least animal extract.

In some examples, the nitrogen containing source comprises at least plant extract.

In some examples, the nitrogen containing source comprises at least a protein hydrolysate and yeast extract.

In some examples, the nitrogen containing source comprises a combination of a protein hydrolysate, yeast extract and at least one of animal extract or plant extract.

In some examples, the amount of the nitrogen containing compounds/source, be it a single source or a combination of sources is between 0.1% and 20% out of the total weight of the nutrient composition, at times between 0.5% and 10%, at times between 0.5% and 5%, at times between 1% and 5%, at times between 1% and 3%, at times between 0.5% and 3%, at times between 0.1% and 3% or any other range within the range of 0.1% and 20%.

In some examples, the nutrient composition comprises one or more carbon containing compounds, acting as a carbon source for the growth of the desired human safeacterium.

In some examples, the carbon containing compound is one or more carbohydrates.

In some examples, the carbohydrate is selected from the group consisting of monosaccharides, disaccharides and oligosaccharides.

In some examples, the carbohydrate is selected from the group consisting of mannitol, arabinose, xylose, glucose, galactose, maltose, raffinose, sucrose, lactose, fructo-oligosaccharide (FOS), sorbitol.

In some examples, the carbon containing compound is or comprises saccharides, these include, inter alia, any one or combination of monosaccharides, e.g. glucose, fructose, galactose, xylose, arabinose; disaccharides e.g. sucrose, lactose, maltose, isomaltulose, trehalose, trealulose and trehalulose; and oligosaccharides i.e. those typically containing 3-10 monosaccharides, such as raffinose (trisaccharide) oligofructose (FOS), galacto-oligosaccharides (GOS), gluco-oligosaccharide, isomalto-oligosacccharides, maltotriose and others.

Other carbohydrates may include sugar alcohols such as mannitol and sorbitol.

In some examples, the carbon containing compound is at least mannitol.

In some examples, the carbohydrate/carbon containing compound comprises at least glucose or at least a combination of glucose and FOS.

In some examples, the amount of the carbohydrates, be it a single source or a combination of carbohydrates, is within the range of 0.5% and 5% out of the total weight of the nutrient composition, at times, between 1% and 5%, at times between 0.5% and 4%, at times between 0.5% and 2.5% and times between 1% and 4%, at times between 1% and 3%, at times between 1% and 2.5% or any other range within the range of 0.5% and 5%.

In some examples, the nutrient composition comprises at least one inorganic mineral and/or at least one inorganic salt.

In some examples, at least one inorganic mineral and/or at least one inorganic salt comprises any one or combination of phosphate, sulfate, potassium, calcium, zinc, magnesium, manganese and iron.

In some examples, the source of such minerals/salts is yeast extract. Notably, the yeast extract can be regarded as providing several types of nutrients in the context of the present disclosure, including the minerals, the vitamins and/or the digested nucleic acids.

In some examples, the nutrient composition comprises at least manganese salts, such as manganese sulfate.

In some examples, the nutrient composition comprises at least magnesium salts, such as magnesium sulfate.

In some examples, the nutrient composition comprises at least sodium salt, such as sodium acetate.

In some examples, the nutrient composition comprises at least potassium salts such as dipotassium hydrogen phosphate.

In some examples, the nutrient composition comprises at least ammonium salts, such as tri-ammonium citrate.

In some examples, the nutrient composition comprises at least a combination of manganese salts and magnesium salts.

In some examples, the amount of the inorganic minerals/inorganic salts, be it a single inorganic component or a combination of inorganics, is within the range of 0.005% and 5% out of the total weight of the nutrient composition, at times between 0.01-2% and 0.02-1%, at times between 0.005% and 2%, at times between 0.05% and 1%, at times between 0.01% and 3% or any other range within the range of 0.005% and 5%.

In some examples, the nutrient composition comprises at least one fatty acid.

In the context of the present invention, the term “fatty acids” denotes simple fatty acids, namely, those having a carboxylic head-group and an aliphatic tail which is either saturated or unsaturated, and yet also complexed fatty acids, where the head-group is substituted with macromolecule, such as a polyoxyethylene group. Such fatty acids may be used also as surfactants and/or emulsifiers of the nutrient composition.

The aliphatic chain may include any number of carbon atoms including short chain fatty acids, having a tail of up to 5 carbon atoms, medium chain fatty acids, containing a tail of 6-12 carbons, long chain fatty acids typically including 13-21 carbon atoms in the tail, and very long chain fatty acids, containing 22 and more carbons in the aliphatic tail.

In some examples, the at least one fatty acid is selected from the group consisting of caprylic acid, capric acid, lauric acid, myristic acid, palmitic acid, stearic acid, arachidic acid, behenic acid, oleic acid, and linoleic acid.

In some examples, the nutrient composition comprises at least one vitamin. The vitamins are known to be important for proper function of organisms and metabolism and are thus essential even at very low quantities.

In some examples, the at least one vitamin is any one or combination of niacin (Vitamin B13), Calcium Pantothenate (calcium salt of vitamin B5), Pyroxidine (Vitamin B6) and Vitamin B12. In some examples, the nutrient composition comprises at least calcium panthenoate.

In some examples, the vitamin component includes at least niacin.

In some examples, the vitamin comprises a combination of niacin and calcium panthenoate.

In some examples, the amount of vitamins is within a range of 0.0001 and 5%, at times between 0.0001% and 3%, at times between 0.005% and 5%, at times between 0.008% and 2%, and any other range between 0.0001% and 5%. Notably, the vitamins can be obtained from the yeast extract and yet can also be externally added.

In some examples, the nutrient composition comprises at least one surfactant/emulsifier.

In some examples, the at least one surfactant is selected from the group consisting of polyoxyethylene (20) sorbitan monolaurate, polyoxyethylene (40) sorbitan monopalmitate, polyoxyethylene (60) sorbitan monostearate, polyoxyethylene (20) sorbitan monooleate and lecithin.

In some examples, the surfactant/emulsifier component of the nutrient composition comprise one or combination of polysorbate 20, polysorbate 40, polysorbate 60 polysorbate 80 and lecithin.

In some further examples, the surfactant/emulsifier component comprises at least polysorbate 80.

In some examples, the amount of surfactant/emulsifier, be it a single surfactant/emulsifier or a combination of several such additives, is within the range of 0.001% and 5% out of the total weight of the nutrient composition, at times between 0.005% and 3%, at times between 0.01% and 2% and times between 0.01% and 3%, at times between 0.05% and 3%, at times between 0.05% and 2%, at times between 0.01% and 1%, at times between 0.05% and 1%, at times between 0.06% and 0.11%, or any other range within the range of 0.001% and 5%.

In some examples, the surfactant/emulsifier is or comprises fatty acid esters or any other surfactant/emulsifier acceptable under the food regulations (E-numbers).

The nutrient composition also comprises, according to some examples, a buffering agent. The purpose of the buffering agent, inter alia, is to maintain the pH of the nutrient composition within a pH range that supports the growth of the desired bacteriocin-producing bacterium. In some examples, the buffering agent comprises any one or combination of phosphoric acid, citric acid, lactic acid and glycine. In some examples, the nutrient composition has a pH in a range of about 5.5 and about 7.

In some examples, the buffering agent comprises at least citric acid.

The amount of the buffering agent will depend on the type of the agent used. In some examples, the amount is selected to provide a pH within the range of 4.0 and 7.0, at times, between 4.0 and 6.0, at times, between 4.2 and 6.0, at times between 4.7 and 5.8, at times between 4.7 and 5.8.

In yet some other or additional examples, the nutrient composition comprises one or more preservatives (growth inhibitors). Non-limiting examples of preservatives include potassium sorbate, sodium benzoate, sodium chloride, sodium lactate, bacteriocins, long chain polyphosphates, ammonium citrate sodium acetate, and maltol.

In one example the preservative is potassium sorbate.

In some examples, the amount of the preservatives added to the nutrient composition is within the range of 0.01% and 0.2% out of the total weight of the composition, at times between 0.05% and 0.1%, at times between 0.02% and 0.08% or any other range within the range of 0.01% and 0.2%. The amount may vary, depending on the preservative used.

In some examples, the nutrient composition also comprises inactivated cell extract of LAB, this may assist in supporting the growth of LAB on the sticker. Examples of such inactivated cell extract may include but not limited to extract of Lactobacillus Lactis, and extract of Lactobacillus Salivarius.

The nutrient composition can be prepared by any method known in the art. In some examples, the adhesive component is prepared by mixing the ingredients of the nutrient composition with the binder and hygroscopic agent until a homogenous mixture is formed.

In some examples the nutrient composition comprises a binder material, preferably, dextrin, in an amount of between about 50 wt % and 70 wt %; a hygroscopic material, preferably sodium chloride and/or propylene glycol in an amount of between 6 wt % and 12 wt %; a nitrogen containing compound(s), preferably soy peptone, in an amount of between about 1 wt % and about 5 wt %; carbohydrates, preferably mannitol, in an amount of between about 0.5 wt % and about 4 wt %; minerals and/or salts, preferably sodium acetate, potassium dihydrogen phosphate, trisodium citrate, magnesium sulfate and/or manganese sulfate, in a total amount of between about 0.05 wt % and 3 wt %; optionally preservation additives, preferably potassium sorbate, in an amount of between about 0.01 wt % and 0.2 wt %; buffering agent, preferably citric acid, in an amount to provide a pH of between 4 and 7.

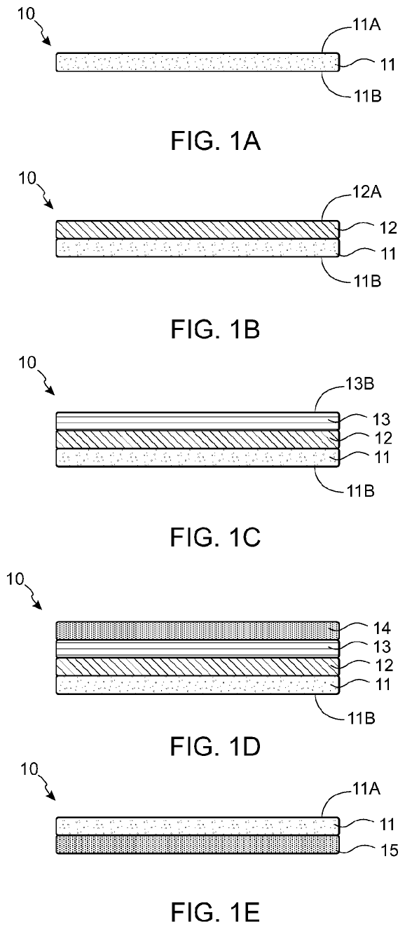

The presently disclosed subject matter provides several implementations of the sticker according to various examples, some of which are described herein below with reference to sticker 10 schematically illustrated in FIGS. 1A-1Q.

FIG. 1A schematically illustrates sticker 10 comprising an adhesive component 11. Adhesive component 11 comprises a carrier composition holding a food grade binder and a nutrient composition suitable for supporting selective growth of one or more human safe bacterium. In fact, the adhesive component 11 can include all or some of the features, in any combination, of the adhesive component described herein above, according to various examples. Adhesive component 11 has an adhesive component first side 11A and an opposite adhesive component second side 11B. Adhesive component 11 is configured to be adhered, via any one of Adhesive component first side 11A and the adhesive component second side 11B, to a package containing goods to be preserved according to various examples as described later herein below.

FIG. 1B schematically illustrates sticker 10 comprising a (first) backing material 12 disposed on the adhesive component first side 11A of the adhesive component 11. In the context of the present disclosure when referring to a “backing material” it is to be understood to encompass a plurality of materials selected from paper (cellulosic blend), fabric, porous metal foil, silicon, synthetic polymers, naturally occurring polymers and combinations thereof, and be permeable to moisture and micro-organisms. The moisture from the goods can permeate through the backing material and activate the adhesive component for stimulating the growth of the human safe bacterium.

First backing material 12 has a first backing material first side 12A facing and adhered to the adhesive component 11 and an opposite first backing material second side 12B.

In some examples, the adhesive component is evenly distributed over the entire backing material surface thus providing 100% coverage. In some examples, the adhesive component is distributed to form a pattern thus providing lesser percentages of coverage. At times the coverage is between about 95% to about 20%, at times between about 90% to about 30%, at times between about 80% to about 40%, at times between about 70% to about 50%, at times between about 50% to about 20%.

FIG. 1C schematically illustrates sticker 10 comprising adhesive component 11, first backing material 12, and a first fixation element 13 disposed over said first backing material second side 12B.

In the context of the present disclosure when referring to a “fixation element” it is to be understood to encompass an element configured to adhere to a designated surface and consequently fix the sticker thereto. In some examples, the fixation element is an inert adhesive (i.e., encompassing the properties of an adhesive and free of the nutrient composition or food grade binders).

In some examples, the first fixation element is evenly distributed over the entire backing material surface thus providing 100% coverage. In some examples, the first fixation element is distributed to form a pattern thus providing lesser percentages of coverage according to the strength of the fixation required while adhering the sticker to the package containing goods.

First fixation element 13 has a first fixation element first side 13A facing and adhered to first backing material 12 and an opposite first fixation element second side 13B configured for adhering to a consumer product (package containing goods) thereby fixing sticker 10 thereto. It is to be understood herein that sticker 10 can be adhered to the package containing goods either via fixation element 13 or via the adhesive component 11 according to the desired exposure of the adhesive component 11 to the water vapors from the goods.

FIG. 1D schematically illustrates sticker 10 comprising adhesive component 11, first backing material 12, first fixation element 13, and a removable first fixation element liner 14 disposed over first fixation element second side 13B.

In the context of the present disclosure when referring to a “removable liner” it is to be understood to encompass a removable layer configured to protect the adhesive properties of the underlying adhesive material and readily removable before use of the sticker.

In the examples, when sticker 10 is to be applied to the package via first fixation element 13, removable first fixation element liner 14 is removed and sticker 10 is applied to the package.

FIG. 1E schematically illustrates sticker 10 comprising adhesive component 11, as shown in example illustrated in FIG. 1A, and a removable adhesive component liner 15 disposed over adhesive component second side 11B. In the context of the present disclosure when referring to a “removable liner” it is to be understood to encompass a removable layer configured to protect the adhesive properties of the underlying adhesive material and readily removable before use of the sticker. In the examples, when sticker 10 is to be applied to the package via adhesive component 11, removable adhesive component liner 15 is removed and the sticker is applied to the package. In some examples, the removable adhesive component liner can be disposed on both sides of the adhesive component.

FIG. 1F schematically illustrates sticker 10 comprising adhesive component 11, first backing material 12, as shown in example illustrated in FIG. 1B, and removable adhesive component liner 15 disposed over adhesive component second side 11B.

FIG. 1G schematically illustrates sticker 10 comprising adhesive component 11, first backing material 12, first fixation element 13, as shown in example illustrated in FIG. 1C, and removable adhesive component liner 15 disposed over adhesive component second side 11B.

FIG. 1H schematically illustrates sticker 10 comprising adhesive component 11, first backing material 12, first fixation element 13, removable first fixation element liner 14, as shown in example illustrated in FIG. 1D, and removable adhesive component liner 15 disposed over adhesive component second side 11B.

FIG. 1I schematically illustrates sticker 10 comprising adhesive component 11, first backing material 12, as shown in example illustrated in FIG. 1B, and a second backing material 16 disposed over adhesive component second side 11B.

In the context of the present disclosure when referring to a “backing material” it is to be understood to encompass a plurality of materials selected from paper (cellulosic blend), fabric, porous metal foil, silicon, synthetic polymers, naturally occurring polymers and combinations thereof, and be permeable to moisture and micro-organisms. The moisture from the goods can permeate through the backing material and activate the adhesive component for stimulating the growth of the human safe bacterium. In some examples the second backing material is same as the first backing material. In some examples, the second backing material is different than the first backing material.

Second backing material 16 has a second backing material first side 16A facing and adhered to adhesive component 11 and an opposite second backing material second side 16B.

In some examples, the adhesive component is evenly distributed over the entire backing material surface thus providing 100% coverage. In some examples, the adhesive component is distributed to form a pattern thus providing lesser percentages of coverage. At times the coverage is between about 95% to about 20%, at times between about 90% to about 30%, at times between about 80% to about 40%, at times between about 70% to about 50%, at times between about 50% to about 20%.

FIG. 1J schematically illustrates sticker 10 comprising the adhesive component 11, first backing material 12, first fixation element 13, as shown in example illustrated in FIG. 1C, and second backing material 16 disposed over the adhesive component second side 11B.

FIG. 1K schematically illustrates sticker 10 comprising the adhesive component 11, first backing material 12, first fixation element 13, removable first fixation element liner 14, as shown in example illustrated in FIG. 1D, and second backing material 16 disposed over adhesive component second side 11B.

FIG. 1L schematically illustrates sticker 10 comprising the adhesive component 11, first backing material 12, second backing material 16, as shown in example illustrated in FIG. 1I, and a second fixation element 17 disposed over second backing material second side 16B.

In the context of the present disclosure when referring to a “fixation element” it is to be understood to encompass an element configured to adhere to a designated surface (be it the goods to be preserved or a package holding the goods) and consequently fix the sticker thereto. In some examples, the fixation element is an inert adhesive (i.e., encompassing the properties of an adhesive and free of the nutrient composition or food grade binders).

In some examples, the second fixation element is evenly distributed over the entire backing material surface thus providing 100% coverage. In some examples, the second fixation element is distributed to form a pattern thus providing lesser percentages of coverage according to the strength of the fixation required while adhering the sticker to the package containing goods.

Second fixation element 17 has a second fixation element first side 17A facing and adhered to second backing material 16 and an opposite second fixation element second side 17B configured for adhering to a consumer product (package containing goods) thereby fixing sticker 10 thereto.

FIG. 1M schematically illustrates sticker 10 comprising the adhesive component 11, first backing material 12, first fixation element 13, second backing material 16, as shown in example illustrated in FIG. 1J, and second fixation element 17 disposed over second backing material second side 16B. It is to be understood herein that sticker 10 can be adhered to the package containing goods either via first fixation element 13 or via second fixation element 17.

FIG. 1N schematically illustrates the sticker 10 comprising adhesive component 11, first backing material 12, first fixation element 13, removable first fixation element liner 14, second backing material 16, as shown in example illustrated in FIG. 1K, and second fixation element 17 disposed over second backing material second side 16B.

FIG. 1O schematically illustrates sticker 10 comprising adhesive component 11, first backing material 12, second backing material 16, second fixation element 17 as shown in example illustrated in FIG. 1L, and a removable second fixation element liner 18 disposed over second fixation element second side 17B.

In the context of the present disclosure when referring to a “removable liner” it is to be understood to encompass a removable layer configured to protect the adhesive properties of the underlying adhesive material and readily removable before use of the sticker.

In some of the examples, when sticker 10 is to be applied to the package via second fixation element 17, removable second fixation element liner 18 is removed and sticker 10 is applied to the package.

FIG. 1P schematically illustrates sticker 10 comprising adhesive component 11, first backing material 12, first fixation element 13, second backing material 16, second fixation element 17 as shown in example illustrated in FIG. 1M, and removable second fixation element liner 18 disposed over second fixation element second side 17B.

FIG. 1Q schematically illustrates sticker 10 comprising adhesive component 11, first backing material 12, first fixation element 13, removable first fixation element liner 14, second backing material 16, second fixation element 17 as shown in example illustrated in FIG. 1N, and removable second fixation element liner 18 disposed over second fixation element second side 17B.

In some of the examples that include both removable first and second fixation element liners 14 and 18, respectively, the two liners can be same as or different than each other.

In some of the examples that include adhesive component liner 15 and any one of removable first and second fixation element liners 14 and 18, respectively, the two liners can be same as or different than each other.

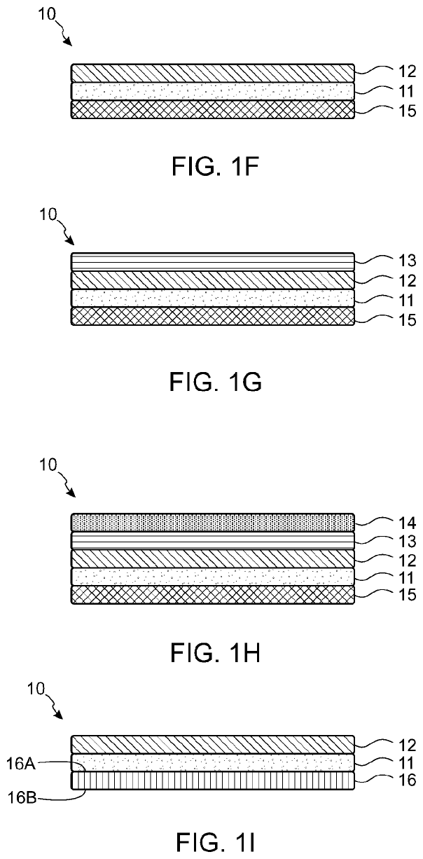

It is to be understood herein that sticker 10 according to any one of the examples described above can be placed in proximity to the goods to be preserved, e.g. by adhering the sticker to the goods or to the package holding the goods, in a manner that the moisture of the goods can activate the nutrient composition and the micro-organisms (bacteria) can grow inside the package. For instance, the sticker can be applied onto an internal side of the package or onto an external side of the package at a moisture passageway formed between an inner volume of the package and the adhesive component for activation of said nutrient composition by water vapors (moisture from the goods), according to various examples, some of which are described herein below with reference to consumer goods packages schematically illustrated in FIGS. 2A to 2E. Accordingly, the presently disclosed subject matter relates to a consumer goods package comprising a packaging element holding consumer goods to be preserved and a sticker according to any one of the examples described above, adhered to said packaging element.

FIG. 2A illustrates a consumer goods package 100 comprising a packaging element 101 holding the consumer goods G to be preserved.

In the context of the present disclosure when referring to a “packaging element” it is to be understood to encompass an envelope, bag, packet, etc. configured for holding consumer goods. Sticker 10 is adhered to an internal side 102 of the packaging element 101 via the adhesive component 11. In some examples, sticker 10 can be the one as illustrated in FIG. 1B.

In some examples, sticker 10 can be the one as illustrated in FIG. 1F with its adhesive component liner removed before application onto the packaging element 101.

The moisture from the goods G can permeate through the first backing material 12 and activate the nutrient composition within the adhesive component 11 to thereby initiate the growth of the human safe bacteria within the package 100.

FIG. 2B illustrates a consumer goods package 200 comprising a packaging element 201 holding the consumer goods G to be preserved. The packaging element 201 includes a moisture passageway 203 between an internal volume of the packaging element 201 and an exterior of the packaging element 201. Sticker 10 is adhered to an external side 205 of the packaging element 201 via the adhesive component 11.

In some examples, sticker 10 can be the one as illustrated in FIG. 1B.

In some examples, sticker 10 can be the one as illustrated in FIG. 1F with its adhesive component liner removed before application onto packaging element 201. The moisture from the goods G can flow through the moisture passageway 203 and activate the nutrient composition within the adhesive component 11 to thereby initiate the growth of the human safe bacteria within the package 200 through the moisture passageway 203.

FIG. 2C illustrates a consumer goods package 100 comprising the packaging element 101 holding the consumer goods G to be preserved. Sticker 10 is adhered to the internal side 102 of the packaging element 101 via the first fixation element 13.

In some examples, sticker 10 can be the one as illustrated in FIG. 1J.

In some examples, sticker 10 can be the one as illustrated in FIG. 1K with its removable first fixation element liner removed before application onto the packaging element 101. The moisture from the goods G can permeate through the second backing material 16 and activate the nutrient composition within the adhesive component 11 to thereby initiate the growth of the human safe bacteria within package 100.

FIG. 2D illustrates a consumer goods package 200 comprising packaging element 201 holding the consumer goods G to be preserved. The packaging element 201 includes the moisture passageway 203 between the internal volume of the packaging element 201 and the exterior of the packaging element 201. Sticker 10 is adhered to the external side 205 of the packaging element 201 via the first fixation element 13.

In some examples, sticker 10 can be the one as illustrated in FIG. 1J.

In some examples, sticker 10 can be the one as illustrated in FIG. 1K with its removable first fixation element liner removed before application onto packaging element 201. The moisture from the goods G can flow through moisture passageway 203, and permeate through first fixation element 13 and the first backing material 12, and activate the nutrient composition within adhesive component 11 to thereby initiate the growth of the human safe bacteria within package 200 through moisture passageway 203.

FIG. 2E illustrates a consumer goods package 100 comprising packaging element 101 holding the consumer goods G to be preserved. Sticker 10 is adhered to the internal side 102 of packaging element 101 via first fixation element 13.

In some examples, sticker 10 can be the one as illustrated in FIG. 1C.

In some examples, sticker 10 can be the one as illustrated in FIG. 1D with its removable first fixation element liner removed before application onto the packaging element 101.

In some examples, sticker 10 can be the one as illustrated in FIG. 1G with its adhesive component liner removed before application onto the packaging element 101. In some examples, Sticker 10 can be the one as illustrated in FIG. 1H with its removable first fixation element liner and adhesive component liner removed before application onto packaging element 101. Adhesive component 11 is directly and fully exposed to the moisture from the goods G for the nutrient composition to be activated thereby to initiate the growth of the human safe bacteria within package 100.

In some examples, the sticker is adhered to goods to be preserved, with, for example, its adhesive component liner removed before application onto the goods and the adhesive component being directly and fully exposed to the moisture from the goods for the nutrient composition to be activated thereby to initiate the growth of the human safe bacteria in the vicinity of the goods.

In some examples, the goods to be preserved comprise food.

In some examples, the food to be preserved is a meat product, including marine animal meat, red meat, poultry, as well as vegan alternatives to meat.

In some examples, the food to be preserved is harvested crop, e.g. fruits, vegetables, seeds and grains, as well as already pealed fruits and vegetables.

In some examples, the food to be preserved is dairy or vegan alternatives to dairy products.

In some examples, the food to be preserved is ready to cook or ready to eat food, such as pre-cooked meals, salads, etc.

In some examples, the food to be preserved is selected from the group consisting of vegetables, fruits, herbs, grains, bakery product, meat and poultry, fish, dairy products sauces and dressings.

In some examples, the consumer goods have a high-water activity and thus more vulnerable to microbial spoilage. Examples of such products include but are not limited to fresh produce, food products such as cheese, meat, salads, spreads, cosmetics and toiletries, home care cleaning products.

In some examples, the consumer goods are those goods that otherwise would require storage within a refrigerator. In the presence of the preservation sticker such products can be stored at room temperature. Examples of such products may include, without being limited thereto, salad spreads, meat, fish, cheese, fruit and vegetables, pre peeled and pre-cut fruits and vegetables.

In some examples, the goods to be preserved/protected are strawberries.

In some examples, the goods to be preserved/protected are cherry tomatoes.

In some examples, the goods to be preserved/protected are avocado fruits.

In some examples, the goods to be preserved/protected are grapes.

In some examples, the goods include home care products such as cleansing solutions which are normally preserved with chemicals.

In some examples, the goods include drugs in the form of an ointment, gel, cream, lotion or a solution, which are normally preserved with chemicals.

It is to be understood herein that all the above-illustrations of the sticker 10 and the packages 100 and 200 are schematic illustrations, and the actual size, structure, and shape of the sticker and/or packages 100/200 can vary without varying the operative features thereof.

More particularly, sticker 10 and various layers thereof have been shown to be thickened for the purposes of illustrations of their respective sides, and in actual products, the layers can be particularly thin for sticker 10 to appear as a conventional sticker for pasting onto a designated surface.

The presently disclosed subject matter further relates to method for preserving consumer goods, the method comprises adhering to a package holding the consumer goods a sticker according to any one of the examples described herein above, in a manner allowing moisture passageway between the consumer goods and the adhesive component.

Alternatively, there is provided a method for preserving consumer goods, the method comprises adhering to the surface of the goods a sticker according to any one of the examples described herein above, in a manner allowing moisture passageway between the consumer goods and the adhesive component.

The presently disclosed subject matter further relates to method for manufacturing a food safe sticker (preservation sticker), comprising mixing a carrier composition comprising a food grade binder with a nutrient composition comprising at least one compound suitable for supporting selective growth of one or more human safe bacterium to form an adhesive component and shaping said adhesive component. The sticker can be a sticker according to any one of the examples described herein above. Accordingly, the method includes disposing onto at least one face or side of the adhesive component a removable liner and/or a backing material in accordance with the example of which the sticker is to be manufactured. For instance, in some examples, the method can include disposing onto a first side of the adhesive component a first backing material, and onto an opposite second side of the adhesive component a removable liner. In some examples, the method can include attaching to a second side, opposite to the one having the adhesive component, of the first backing material a fixation element carrying on an opposite side to the backing material, a removable liner.

The presently disclosed subject matter further relates to method for manufacturing a food safe sticker (preservation sticker), comprising providing an adhesive component comprising a carrier composition holding a nutrient composition. The carrier composition comprises a food grade binder and the nutrient composition comprises at least one compound suitable for supporting selective growth of one or more human safe bacterium. In some examples, the method can comprise disposing onto at least one side of the adhesive component at least one of a first backing material and a first removable liner and optionally onto an opposite second side of the adhesive component at least one of a second backing material and second removable liner. The first backing material and the second backing material can be the same or different and the first removable liner and the second removable liner can be the same or different.

The method further comprises disposing onto at least one of the first backing material and second backing material at least one fixation element. In some examples, the fixation element can have on an opposite side to the at least one of said first backing material and second backing material, a removable liner.

In some examples, the method can comprise disposing onto a first side of the adhesive component a removable adhesive component liner and on an opposite second side of the adhesive component a backing material.

It is to be understood herein that the adhesive component is as defined in any one of the examples described herein.

### DETAILED DESCRIPTION OF NON-LIMITING EMBODIMENTS

### Example 1—Preservation of Backed Products

### Preparation of the Preservation Adhesive Compositions

Two food preservation adhesive compositions were prepared according to Tables 1 and Table 2.

TABLE 1
Adhesive composition No. 1

| | |
|---|---|
| Ingredient | Amount (wt %) |

Binder material

| | |
|---|---|
| Dextrin | 61.00% |

Hygroscopic material

| | |
|---|---|
| Sodium Chloride | 10.00% |

Nitrogen containing compounds/source

| | |
|---|---|
| Soy Peptone | 1.600% |

Carbohydrates

| | |
|---|---|
| Mannitol | 1.600% |

Minerals/Salts

| | |
|---|---|
| Sodium Acetate | 0.400% |
| Potassium dihydrogen phosphate | 0.160% |
| Trisodium citrate | 0.160% |
| Magnesium sulfate | 0.015% |
| Manganese sulfate | 0.007% |

Preservation additive

| | |
|---|---|
| Potassium Sorbate | 0.15% |

Buffering agent

| | |
|---|---|
| Citric Acid | q.s (pH 4-6) |

Water

| | |
|---|---|
| RO Water | 24.458% |
| Total | 100.0% |

TABLE 2
Adhesive composition No. 2

| | |
|---|---|
| Ingredient | Amount (wt %) |

Binder material

| | |
|---|---|
| Dextrin | 61.00% |

Hygroscopic material

| | |
|---|---|
| Sodium Chloride | 2.00% |
| Glycerin | 8.00% |

Nitrogen containing compounds/source

| | |
|---|---|
| Soy Peptone | 1.600% |

Carbohydrates

| | |
|---|---|
| Mannitol | 1.600% |

Minerals/Salts

| | |
|---|---|
| Sodium Acetate | 0.400% |
| Potassium dihydrogen phosphate | 0.160% |
| Trisodium citrate | 0.160% |
| Magnesium sulfate | 0.015% |
| Manganese sulfate | 0.007% |

Preservation additive

| | |
|---|---|
| Potassium Sorbate | 0.1% |

Buffering agent

| | |
|---|---|
| Citric Acid | q.s (pH 4-6) |

Water

| | |
|---|---|
| RO Water | 24.958% |
| Total | 100.0% |

The adhesive compositions were prepared by mixing all ingredients and suspending the same in the reverse osmosis water that was pre-heated to 85° C. to form a mixture. The mixture was mixed for 20-40 minutes to ensure complete dissolution, after which the mixture was allowed to cool to room temperature.

The adhesive compositions were coated on a paper backing material using a sticker paper coating machine to provide the food preservation stickers.

It is noted that adhesive compositions can be fixed onto a paper backing material manually, e.g. using a simple brush, as well as using any one of a flexo printing machine, a roll coating machine, brushes, sprays or any other method for dispensing liquid based adhesives.

### Food Preservation

### Bread:

a sticker was prepared according to the procedure described above, yet with an adhesive composition as detailed in Table 3 fixed onto a paper backing material.

TABLE 3
Adhesive Composition No. 3

| | |
|---|---|
| Ingredient | Amount (wt %) |

Binder material

| | |
|---|---|
| Dextrin | 60.00% |

Hygroscopic material

| | |
|---|---|
| Sodium Chloride | 8.00% |
| Propylene Glycol | 8.00% |

Nitrogen containing compounds/source

| | |
|---|---|
| Yeast Extract | 0.600% |
| Potato Peptone | 3.250% |
| Glycine | 0.250% |

Carbohydrates

| | |
|---|---|
| Mannitol | 3.200% |

Minerals/Salts

| | |
|---|---|
| Sodium Acetate | 0.900% |
| Potassium dihydrogen phosphate | 0.300% |
| Trisodium citrate | 0.300% |
| Iron Sulfate | 0.020% |
| Magnesium sulfate | 0.030% |
| Manganese sulfate | 0.015% |

Preservation additive

| | |
|---|---|
| Potassium Sorbate | 0.150% |

Vitamins

| | |
|---|---|
| Calcium Pantothenate | 0.030% |
| Niacin | 0.030% |

Fatty Acids additives

| | |
|---|---|
| Caprylic Acid | 0.500% |
| Polyoxyethene (20) sorbitan | 0.110% |
| monooleate (polysorbate 80) | |

Buffering agent

| | |
|---|---|
| Citric Acid | q.s (pH 4-6) |

Water

| | |
|---|---|
| RO Water | 14.315% |
| Total | 100.0% |

Adhesive Composition No. 3 (fixed onto a paper backing material) was then tested on the preservation of bag-packed bread after a period of 20 days.

Specifically, Adhesive Composition No. 3 was fixed to an internal side of two bread bags, facing the top side of the bread loaves. Each bag was then re-sealed.

For the control group, two bags of the same bread loaves were opened and re-sealed without introducing the adhesive composition.

The bag packed bread loaves (tested and control) were stored under the same conditions (ambient/room temperature). A daily visual inspection was carried out to detect signs of mold formation and growth.

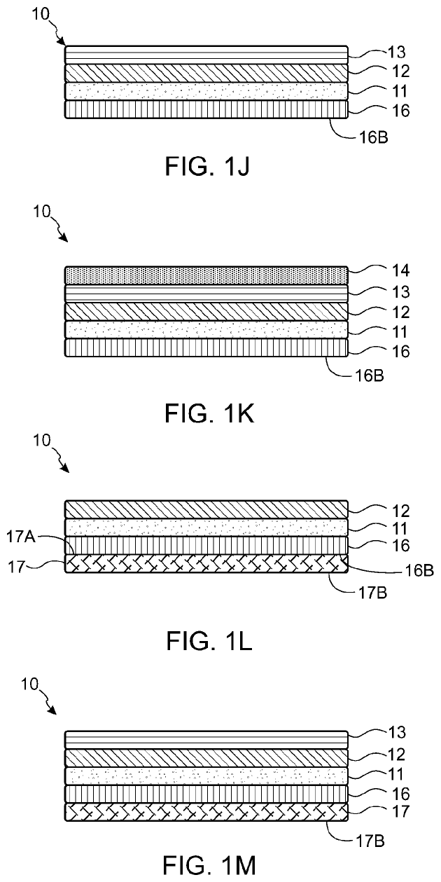

First signs of mold appeared in the control group after 13 days of storage and were significantly more apparent after 20 days with almost complete coverage of the bread. FIGS. 3A-3C show the difference between time zero (after re-sealing, FIG. 3A), after 13 days (the developed molds being circled, FIG. 3B) and after 20 days (FIG. 3C), with the two left loaves in each of FIGS. 3A-3C representing the preserved/treated breads, and the two right loaves representing the non-treated (control) loaves. The absence of molds in the treated group (including Adhesive Composition No. 3) is pronounced as compared to the significant formation of mold is the non-treated (control) loaves (FIG. 3C).

### Sponge Cake

The effect of Adhesive Composition No. 3 (fixed on a paper backing material) on the preservation of sponge cake was also tested.

Firstly, the cakes were prepared according to manufacturer's instructions (Pillsbury) and allowed to cool to room temperature before bag packaging within polyethylene zipper bags.

Adhesive Composition No. 3 was fixed to the internal side of the bags of 2 packed sponge-cake (facing the top side of the cake) and the bags were re-sealed. As control group, similar opening and re-sealing was conducted with two other sponge-cake bags.

The 4 bag packed sponge cakes were then stored for 15 days, at ambient temperature.

Molds appeared on the cakes of the control group after 10 days, while similar volume of molds appeared on the cakes packed with Adhesive Composition No. 3 appeared only ager 15 days, i.e. the Adhesive Composition No. 3 increased the shelf life of the cakes by about 50%.

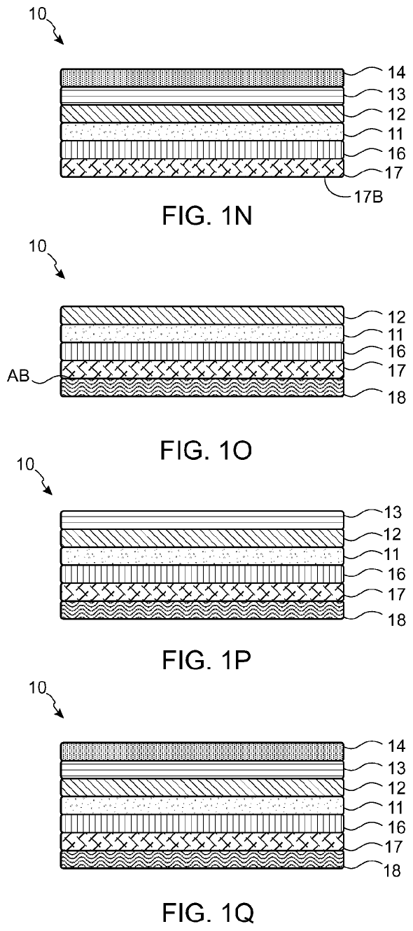

FIGS. 4A-4C show the sponge cakes at zero time (after re-sealing, FIG. 4A), after 10 days (the formation of molds being circled, FIG. 4B) and after 15 days (molds being circled, FIG. 4C. In each of FIGS. 4A and 4C, the two left cakes represent the preserved/treated cakes, and the two right cakes represent the non-treated (control) cakes. In FIG. 4B, the left cake is a preserved cake while the right cake is the control.

The absence of molds in the treated group after 10 days is evidence for the preservation effectiveness of Adhesive Composition No. 3 as compared to the non-treated cakes.

### Mushroom Pack

The effect of Adhesive Composition No. 3 on the preservation of shrink film packed mushrooms was also examined.

A hole was created in the shrink film of two mushroom packs and Adhesive Composition No. 3 was fixed to the outer side of the shrink film in a manner resealing the mushroom pack. As control, two shrink film packed mushrooms were used, without any change.

The packs were monitored for change of color (discoloration) which is an immediate sign of microbial activity (bacteria and/or mold growth).

After 3 days discoloration was apparent in the non-treated/control packs only (not shown).

### Example 2—Fruit and Vegetable Preservation

### Fabrication of a Food Preservation Sticker

Another sticker according to the presently disclosed subject matter was prepared to include the following layers:

A first backing material comprising a polypropylene layer featuring a fixation element and a removable fixation liner. The first, PP, backing material was coated with an adhesive composition as detailed in Table 4, followed by an additional layer of craft paper applied using an industrial laminating machine. The resulting sticker was then cut into circular shaped stickers with a 35 mm diameter.

TABLE 4
Adhesive composition No. 4

| | |
|---|---|
| Ingredient | Amount (wt %) |

Binder material

| | |
|---|---|
| Dextrin | 50% |

Hygroscopic material

| | |
|---|---|
| Sodium Chloride | 8% |
| Propylene Glycol | 8% |

Nitrogen containing compounds/source

| | |
|---|---|
| Soy Peptone | 2.6% |
| Beef Extract | |
| Yeast Extract | 0.500 |

Carbohydrates

| | |
|---|---|
| Mannitol | 2.7% |

Minerals/Salts

| | |
|---|---|
| Sodium Acetate | 0.75% |
| Potassium dihydrogen phosphate | 0.28% |
| Trisodium citrate | 0.28% |
| Iron Sulfate | 0.038% |
| Magnesium sulfate | 0.05% |
| Manganese sulfate | 0.025% |

Vitamins

| | |
|---|---|
| Niacin | 0.050 |
| Calcium Panthotenate | 0.040 |

Fatty Acids additives

| | |
|---|---|
| Caprylic Acid | 0.500% |
| Polyoxyethene (20) sorbitan monooleate (polysorbate | 0.110% |
| 80) | |

Preservation additive

| | |
|---|---|
| Potassium Sorbate | 0.15% |

Buffering agent

| | |
|---|---|
| Citric Acid | q.s (pH 4-6) |

Water

| | |
|---|---|
| RO Water | 25.927q.s |
| Total | 100.0% |

The stickers were used for fruit and vegetable storage experiments described herein below.

Specifically, the fruits or vegetables packed with a sticker are referred to as the “Experimental” group, while those packed without a sticker are referred to as the “Control” group.

### Shelf-Life Extension of Strawberries

The effect of the stickers on pathogen colonization and damage of strawberries was evaluated.

### Materials:

Sticker—according to composition 4 in Table 4
Strawberries—Fresh strawberries free of externally added fungicides or bactericides were transported under ambient environmental conditions and used within 3 hours post harvest.

### Methods

Strawberry Packaging: Freshly harvested strawberries, weighing between 250 g, were packed in designated clamshells (PET trays with a plastic lid). In the Experimental group, a sticker was positioned underneath the plastic lid.

Control group included strawberries harvested from the same batch as the Experimental group, but devoid of a sticker. Both the Experimental package and the Control package were packed in an identical manner.

Storage Conditions: Strawberries were stored under different conditions (see also Table 6A):
13° C. with 75% RH (Relative Humidity);
Ambient room temperature (22° C.-25° C.);
Temperature fluctuations: strawberries were stored in 4° C. 75-90% RH and taken out of refrigeration to 13° C. within specified time intervals to reflect changes in temperatures which occur occasionally in a supply chain and at stores display.

The chosen storage conditions aimed to foster the growth of bacteria induced by a sticker while also replicating standard and extreme storage conditions along the supply chain.

Trial Duration: The trials were conducted over periods ranging from 3 to 13 days. Detailed durations for each trial are listed in Table 6A.

Experimental Procedure: A total of 10.5 kg of strawberries (250 g/package) were subjected to 6 distinct trials as detailed in Table 6A.

In both the Control group and Experimental group, the strawberries were assessed at different sampling intervals for:

Visual Analysis: This involved checking for color alterations and signs of decay. Qualitative evaluations were supplemented with photographic evidence.

Fruit Microbial Contamination Tests: Total microbial counts, as well as yeast and mold counts, were determined as per ISO standard 4833 (ISO 4833-1:2013, Microbiology of the food chain, Horizontal method for the enumeration of microorganisms).

Bacterial Growth Identification: Bacteria grown on the nutrient blend was extracted from the sticker after fruit incubation was identified using any one of: Gram Stain protocol, Catalase Test, Mannitol test, Lechitanase test and molecular identification using 16S sequencing (according to NCBI (National Center for Biotechnology Information) guidelines)).

The trials conditions are presented in Table 6A, and the results are presented in Table 6B.

TABLE 6A
Conditions of Trials

| Trial | Duration | Total quantity | |
|---|---|---|---|
| Code | (days) | tested * (gr) | Conditions |
| Str. 1 | 7 | Control: 750 | 13° C., 75% RH |
| | | Treatment: 750 | |
| Str. 2 | 7 | Control: 750 | 13° C., 75% RH |
| | | Treatment: 750 | |
| Str. 3 | 3 | Control: 750 | Ambient (22° C.-25° C.) |
| | | Treatment: 750 | Temp. |
| Str. 5A | 9 | Control: 1000 | 5 days at 4° C./ |
| | | Treatment: 1000 | 75-90% RH followed |
| | | | by 4 days at 13° C./75% RH. |
| Str. 5B | 12 | Control: 1000 | 5 days at 4° C./ |
| | | Treatment: 1000 | 75-90% RH followed |
| | | | by 7 days at 13° C./75% RH. |
| Str. 5C | 13 | Control: 1000 | 5 days at 4° C./ |
| | | Treatment: 1000 | 75-90% RH followed |
| | | | by 8 days at 13° C./75% RH. |

* Product quantity per package was 250 gr

TABLE 6B
Results

| Trial | | Strain identification (16S |
|---|---|---|
| Code | Visual/bacterial tests | sequencing) |
| Str. 1 | Mold count reduction by 2 -fold | Bacillus subtilis |
| | after 7 days | related specie* |
| Str. 2 | 3.7 -fold reduction in mold | Bacillus subtilis |
| | spoilage after 7 days | related specie* |
| Str. 3 | 2.7 -fold reduction in mold | Bacillus subtilis |
| | soilage after 3 days | related specie* |
| Str. 5A | 3.9-fold reduction in mold | Bacillus subtilis |
| | soilage after 9 days | related specie* |
| Str. 5B | 3.4-fold reduction in mold | Bacillus subtilis |
| | soilage after 12 days | related specie * |
| Str. 5C | 2.2-fold reduction in mold | Bacillus subtilis |
| | soilage after 13 days | related specie * |

*Identified by microscopy and biochemical tests.

Trial groups Str. 1, Str. 2, and Str. 3 were designed to test sticker performance on strawberries stored in different temperature conditions and were performed on the same batch of strawberries. In these trials, each package contained 250 gr of strawberries (per package).

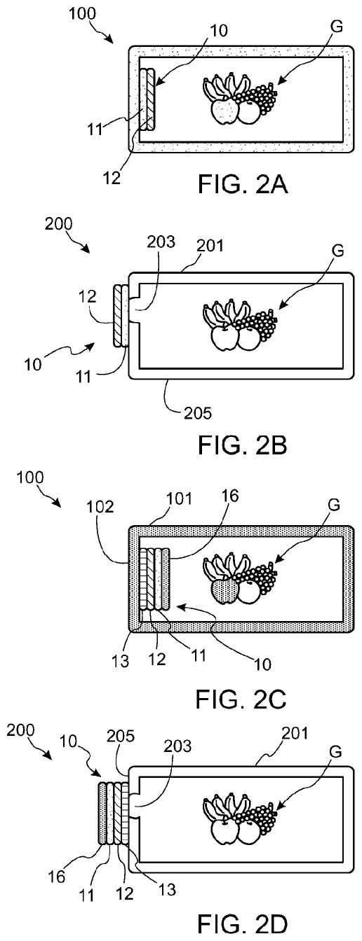

In Str. 1 mold counts on strawberries in the Experimental and Control groups were performed according to ISO standard 4833 at starting point (TO), after 3 day (T3) and after 7 days (T7) of storage at 13° C./75% RH representing extreme storage conditions. Results are presented in FIG. 5 as the average count of 2 (at T0) or 3 strawberries packages (at T3, T7).

At T0, 2 packages of strawberries were sampled at the time they arrived at the laboratory.

At T3 and T7, 3 packages from a Control group and 3 packages from an Experimental group were taken out of storage and sampled.

FIG. 5 shows that the sticker was capable of inhibiting mold propagation on the strawberries from the Experimental group, with a 1.3, 1.6 logs reduction in mold count at T3 and T7, respectively. The inhibition effect is noticeable beginning from T3, with a prolonged effect evident at T7.

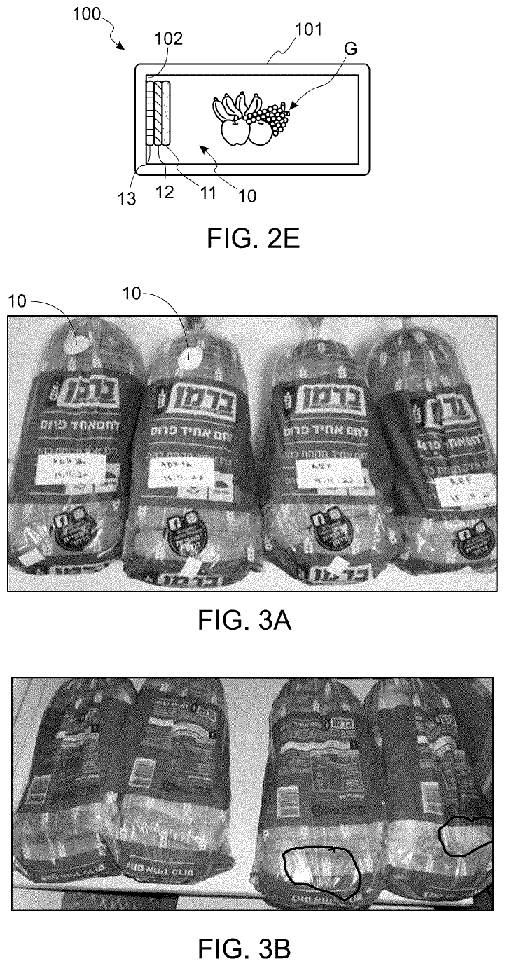

Mold propagation inhibition is more readily seen in FIGS. 6A-6D showing mold count plates from trial Str. 1 after 7 days as compared to Control and the reduction in mold colonies including: control total count (FIG. 6A), control yeast and mold (FIG. 6B), experimental total count (FIG. 6C) and experimental yeast and mold (FIG. 6D). The effect is shown when comparing the mature mold colonies obtained from the Control group (FIG. 6B) to the inhibited small mold colonies obtained from the Experimental group (FIG. 6D).

These results indicate that the sticker inhibited growth of spoilage microorganisms such as molds at prolonged storage at 13° C. It is assumed that mold inhibition in the experimental group was a result of a microbial population shift induced by the selective growth of Bacillus sp., naturally present in the surrounding of the fruits, on the nutrient blend. To verify Bacillus growth, microscopic, biochemical, and molecular tests were performed on the microbial population that grew inside the stickers in 3 triplicates of the trial.

Preliminary testing of isolated colonies using Gram staining and microscopy imaging (data not shown) indicated the presence of Bacillus colonies grown from the nutrient blend. 16S sequencing confirmed the presence of Bacillus subtilis related species in Str. 1.

The microbial growth from the nutrient blend was shown to have the following characteristics:
A single type of colony grew from all 3 triplicates.
Same type of single colony grew on the nutrient blend from a total of 6 different treated strawberry packages at T3 and T7.
Colony morphology: large, white and asymmetric, with wavy margins, and opaque texture.
Microscope appearance: Gram positive stain, having a shape of Bacillus.
Biochemical testes: Catalase—positive, Lecitinase—Negative, Mannitol—positive.
Biochemical and Microscopic analysis indicated one type of Bacillus isolate with same characteristics from all the tested sachets.
16S sequencing results confirmed B. subtilis growth from the nutrient blend.

Trials Str. 2, Str. 3 were designed to evaluate the sticker efficacy in reducing the visual signs of spoilage. The trials were performed in different temperature conditions representing extreme temperature conditions (13° C./75% RH, 25° C./75% RH).

In these trials the Control group and Experimental group, each, contained 6 packages of strawberries. Each group was divided into 2 subgroups which were placed at 2 storage temperatures: 13° C. (6 packages total for each subgroup at each temperature).

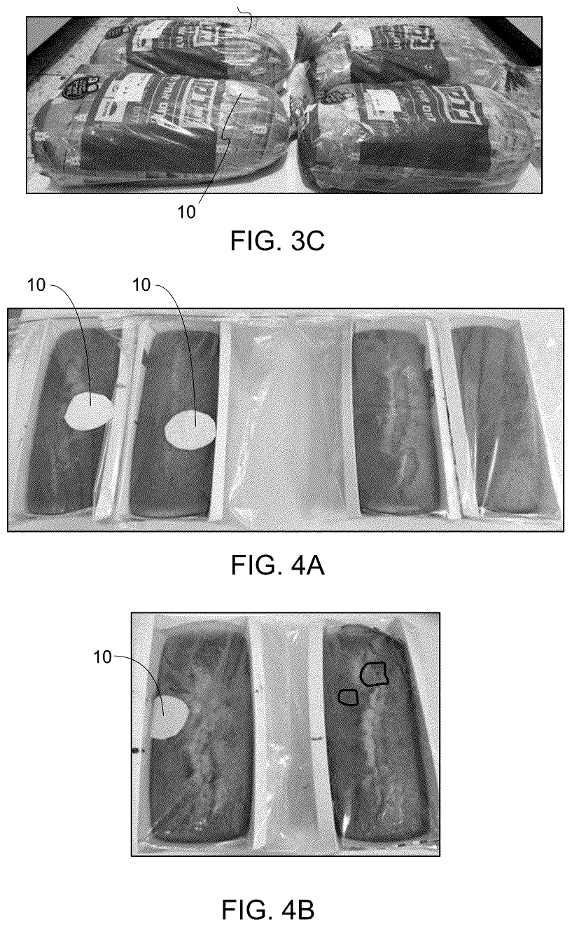

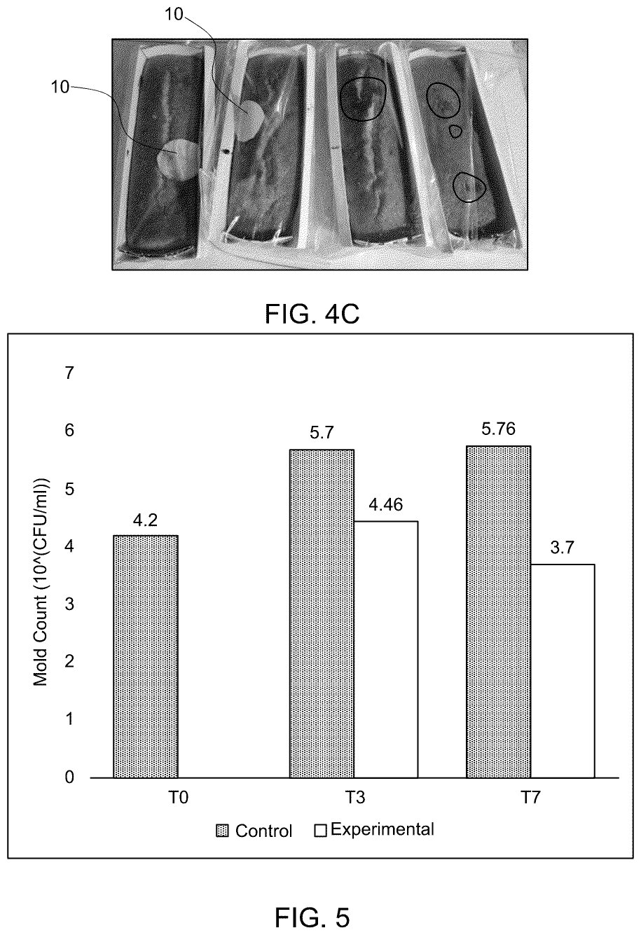

FIGS. 7A-7D and FIGS. 8A-8D show, respectively, strawberries stored at 13° C. and at 25° C. (ambient temp), as part of trial Str. 2, and Str, 3. In these trials, each package contained 250 gr of strawberries.

Specifically, FIG. 7A shows the Control group at T0 of trial Str. 2 after storage at 13° C. and 75% RH; FIG. 7B shows the Control group at T7 of trial Str. 2 after storage at 13° C. and 75% RH; FIG. 7C shows the Experimental group at T0 of trial Str. 2 after storage at 13° C. and 75% RH; and FIG. 7D shows the Experimental group at T7 of trial Str. 2 after storage at 13° C. and 75% RH.

Further specifically, FIG. 7A and FIG. 7B show strawberries in the control group, stored at 13° C., with significant signs of microbial spoilage after 7 days of storage (FIG. 7B), with 12 moldy strawberries out of 38 (31.6% spoilage). In the experimental group (FIGS. 7C, 7D), presence of a sticker reduced the spoilage percent to only 8.5%, with 4 moldy strawberries out of 47 (3.7-fold reduction in mold spoilage) after the 7 day storage (FIG. 7D).

FIGS. 8A-8D show the same batch of strawberries stored at 25° C., with the follow up being at T3. As can be seen, similar to storage at 13° C., the strawberries in the control group (FIGS. 8A-8B) showed significant signs of microbial spoilage after 3 days of storage (FIG. 8B), with 21 moldy strawberries out of 43 (48.8% spoilage). The sticker reduced spoilage percent to only 17.7%, with 8 moldy strawberries out of 45 (17.7% spoilage, 2.7-fold reduction in mold spoilage) after the 3 days storage (FIG. 8D).

Temperature changes are unavoidable during the shipping of fresh produce and at the store display. Trials Str.5A, 5B and 5C aimed to evaluate the sticker's effectiveness under such variable temperature conditions encountered during transportation. In each trial the tested fruits were stored at 4° C. for 5 days followed by storage at 13° C. at variable time intervals of 4 days (Trial Str. 5A), 7 days (Trial Str. 5B) and 8 days (Trial Str. 5C) to evaluate the sticker performance during shelf life.

In these trials, the Control group, and Experimental group, each, contained 12 packages of strawberries. Each group was divided into 3 subgroups.

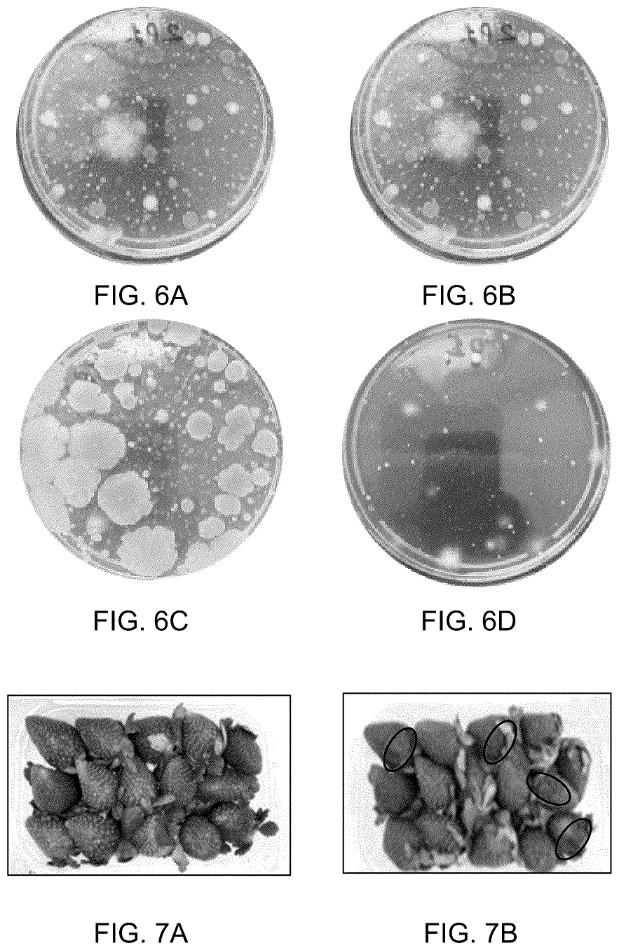

FIGS. 9A-9D show strawberries stored at 4° C. for 5 days followed by 4 days in 13° C. and in total 9 days of follow up (T9), with 16 moldy strawberries out of 65 (24.8% spoilage). In the control group (FIG. 9B), presence of sticker reduced the spoilage percent to only 6.3% with 4 moldy strawberries out of 63 (6.3% spoilage, 3.9-fold reduction in mold spoilage) after the total of 9 days storage (FIG. 9D).

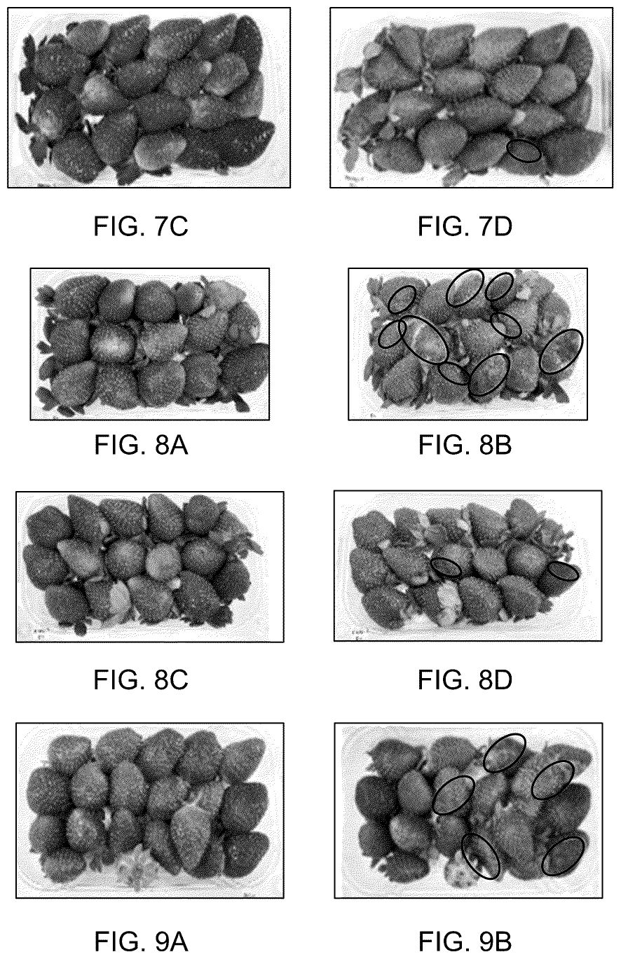

FIGS. 10A-10D show strawberries stored at 4° C. for 5 days followed by 7 days in 13° C. and in total 12 days of follow up (T12), with 13 moldy strawberries out of 64 (20.3% spoilage). In the control group (FIG. 10B), presence of sticker reduced the spoilage percent to only 5.9% with 4 moldy strawberries out of 68 (3.4-fold reduction in mold spoilage) after the total of 12 days storage as shown in the Experimental group (FIG. 10D).

FIGS. 10A-10D show strawberries stored at 4° C. for 5 days followed by 7 days in 13° C. and in total 12 days of follow up (T12). The results show that there were 21 moldy strawberries out of 54 (38.9% spoilage). In the Control group (FIG. 10B), presence of sticker reduced the spoilage percent to only 17.5% with 10 moldy strawberries out of 57 (2.2-fold reduction in mold spoilage) after the total of 12 days storage (FIG. 10D).

Microscopic and biochemical tests performed on the bacteria developed on the nutrient blend confirmed the growth of B. subtilis related specie at all storage intervals.

### Shelf-Life Extension of Cherry Tomatoes

The effect of stickers on pathogen colonization and damage of cherry tomatoes was also evaluated.

### Materials:

Sticker—According to composition 4 in Table 4
Cherry tomatoes—were bought from a local supermarket as sealed packages, specifically PET trays with perforated plastic film, each weighing 500 grams and originating from the identical harvest batch.

### Methods

Cherry tomato Packaging: The cherry tomatoes were separated into Control group and Experimental group. A sticker was affixed to the inner side of the sealing plastic film by making a small incision in the film. The Control group included cherry tomatoes harvested from the same batch as the Experimental group, but devoid of a sticker. Both the Experimental package and the Control package were packed in an identical manner.

Storage Conditions: for all groups, the cherry tomatoes were stored under 13° C. with 75% RH (Relative Humidity).

Trial Duration: The trials were conducted over periods ranging from 6 to 10 days. Detailed durations for each trial are listed in Table 7A.

Experimental Procedure: A total of 26 kg (52 units) of cherry tomatoes (500 g/package) were subjected to 4 distinct trials as detailed in Table 7A. In both the control and experimental groups, cherry tomatoes were assessed at different sampling intervals for:

Visual Analysis: This involved checking for color alterations and signs of decay. Qualitative evaluations were supplemented with photographic evidence.

Fruit Microbial Contamination Tests: Total microbial counts, as well as yeast and mold counts, were determined as per ISO standard 4833.

Bacterial Growth Identification: Bacteria grown on the nutrient blend was extracted from the sticker after fruit incubation was identified using Gram Stain protocol, Catalase Test, Mannitol test, Lechitanase test and molecular identification using 16S sequencing (according to NCBI (National Center for Biotechnology Information) guidelines)).

TABLE 7A
Conditions of Trials

| Trial | Duration | Number of tested | |
|---|---|---|---|
| Code | (days) | units | Conditions |
| Tmt. 1 | 6 | Control: 9 | 13° C., 75% RH |
| | | Treatment: 9 | |
| Tmt. 2 | 10 | Control: 3 | 13° C., 75% RH |
| | | Treatment: 3 | |
| Tmt. 3 | 7 | Control: 9 | 13° C., 75% RH |
| | | Treatment: 9 | |
| Tmt. 4 | 10 | Control: 3 | 13° C., 75% RH |
| | | Treatment: 3 | |

*Product quantity per package was 500 gr

TABLE 7B
Results of Trials

| Trial | | Strain identification (16S |
|---|---|---|
| Code | Visual/bacterial tests | sequencing) |
| Tmt. 1 | Visible mold reduction on plates | Bacillus subtilis |
| | by 1.5 fold | related specie |
| Tmt. 2 | Reduction of spoilage rate | Bacillus subtilis |
| | by 2.9 fold | related specie |
| Tmt. 3 | Visible mold reduction on | Bacillus subtilis |
| | plates by 2.96 fold | related specie |
| Tmt. 4 | Reduction of spoilage | Bacillus subtilis |
| | rate by 1.9 fold | related specie |

*identified by microscopy and biochemical tests.

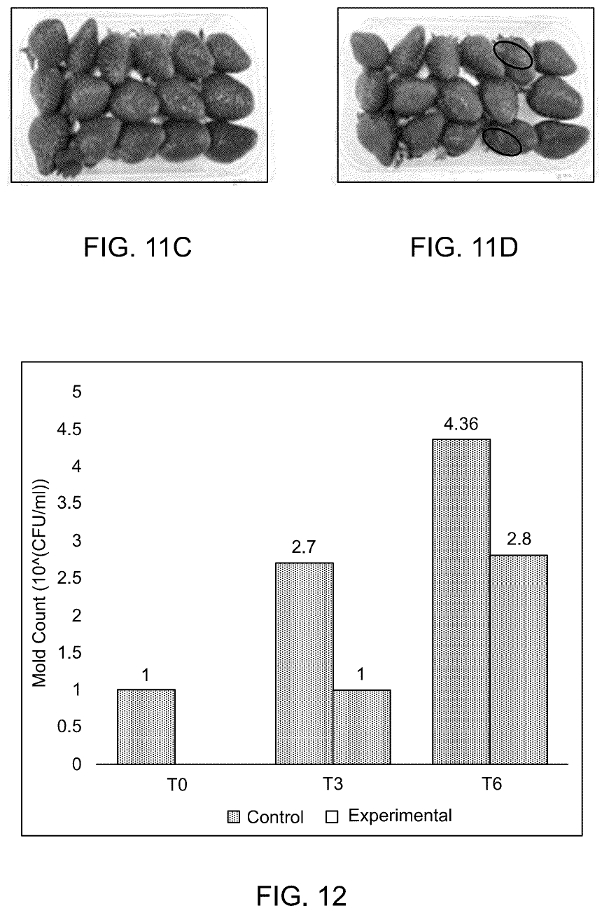

Mold counts on in Experimental and Control groups were performed according to ISO standard 4833 at starting point (TO), after 3 days (T3) and after 6 days (T6). Results are presented in FIG. 12 as the average count of 2 (at T0) or 3 cherry tomatoes packages (at T3, T6).

At T0, 2 packages of tomatoes were sampled at the time they arrived at the laboratory.

At T3 and T6, 3 packages from a Control group and 3 packages from an Experimental group were taken out of storage and sampled.

FIG. 12 shows that the sticker was capable of inhibiting mold propagation on the cherry tomatoes from the experimental group, with a 2.7 logs reduction in mold count at T3 and 1.5 logs at T6.

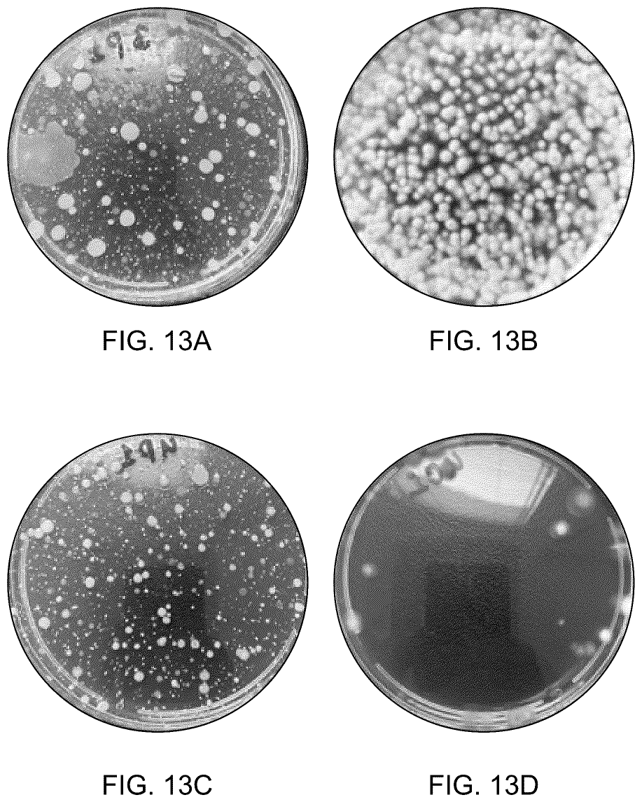

Mold propagation inhibition is more readily seen in FIGS. 13A-13D, when comparing the number of mold colonies obtained from the Control group (FIG. 13B) to the limited number of mold colonies obtained from the Experimental group (FIG. 13D), from plates of trials identified as Tmt. 1.

These results indicate that the sticker inhibited growth of spoilage microorganisms such as molds at prolonged storage at 13° C. It is assumed that mold inhibition in the Experimental group was a result of a microbial population shift induced by the selective growth of Bacillus sp., naturally present in the surrounding of the fruits, on the nutrient blend. To verify Bacillus growth, microscopic, biochemical, and molecular tests were performed on the microbial population that grew inside the sticker.

Testing of isolated colonies using Gram staining and microscopy imaging indicated the presence of Bacillus colonies grown from the nutrient blend.

The microbial growth from the nutrient blend was shown to have the following characteristics:
A single type of colony grew from all 3 triplicates.
Same type of single colony grew on the nutrient blend from a total of 6 different treated cherry tomatoes packages at T3 and T6. Colony morphology: large, white and asymmetric, with wavy margins, and opaque texture.
Microscope appearance: Gram positive stain, having a shape of Bacillus.
Biochemical testes: Catalase—positive, Lecitinase—Negative, Mannitol—positive
Biochemical and Microscopic analysis indicated one type of Bacillus isolate with same characteristics from all the tested sachets.
16S sequencing results confirmed that B. subtilis related specie growth from the nutrient blend at trial Tmt. 1.

The purpose of trial Tmt. 2 was to evaluate the quality of the same cherry tomatoes during shelf life according to their acceptability for market per selling unit.

The cherry tomatoes were stored at 13° C./75% relative humidity for a duration of 10 days, categorized into sub-groups based on their respective quality scores for both the control and experimental groups.

Images were taken (not shown) to record the visual appearance. Each cherry tomato in each tray was scored in a scale of 1-4 where:
1—severe signs of decay
2—moderate signs of decay
3—slight signs of decay, soft to the touch
4—no signs of decay, firm berry

The results are also summarized in Table 8, where the number of cherry tomatoes at each score, from each box, is indicated. Further indicated is the total number of tomatoes in each score, from each box (“Total”), % spoiled tomatoes taking into account the tomatoes under Scores 1 and 2 (“% Spoiled”); mean of spoiled cherries (under to Score 1 and 2) each box (“Mean spoiled”), % of high quality (i.e. score 4) in each box (“% High quality”), and mean of high quality of tomatoes (“Mean High quality”)

TABLE 8
Results of 10 days follow up of trail Tmt. 2

| | Control group | | | Experimental Group | | |
|---|---|---|---|---|---|---|
| Score # | Box 1 | Box 2 | Box 3 | Box 1 | Box 2 | Box 3 |
| 1 | 3 | 3 | 2 | 0 | 0 | 1 |
| 2 | 3 | 3 | 3 | 1 | 2 | 2 |
| 3 | 7 | 7 | 13 | 13 | 9 | 6 |
| 4 | 12 | 12 | 9 | 17 | 17 | 15 |
| Total | 12 | 12 | 9 | 17 | 17 | 15 |
| % Spoiled | 24.0% | 24.0% | 18.5% | 3.2% | 7.1% | 12.5% |
| Mean | 22.2% (5.9) | | | 7.6% | | |
| Spoiled | | | | | | |
| (STDEV) | | | | | | |
| % High | 48.0% | 48.0% | 33.3% | 54.8% | 60.7% | 62.5% |
| Quality | | | | | | |
| Mean High | 43.1% (8.5) | | | 59.3% (4.0) | | |
| Quality | | | | | | |
| (STDEV) | | | | | | |

It can be concluded from Table 8 that the sticker of the present disclosure reduced the % of soilage from 22.2% in the Control group to 7.6% in the Experimental group with a rate of 2.9-fold.

Moreover, the presently disclosed sticker enhanced the overall excellence of the cherry tomatoes, evident in the comparison of fruits with a score of 4 (the highest score) between the Control and Experimental groups. This percentage increased from 43.1% in the Control group to 59.3% in the Experimental group, representing a 1.4-fold improvement. (see Table 8 above).

The purpose of trials Tmt. 3 and Tmt. 4 was to show repeatability in the results using the same testing methodologies. The cherry tomatoes that served these trials were from the same batch of harvest.

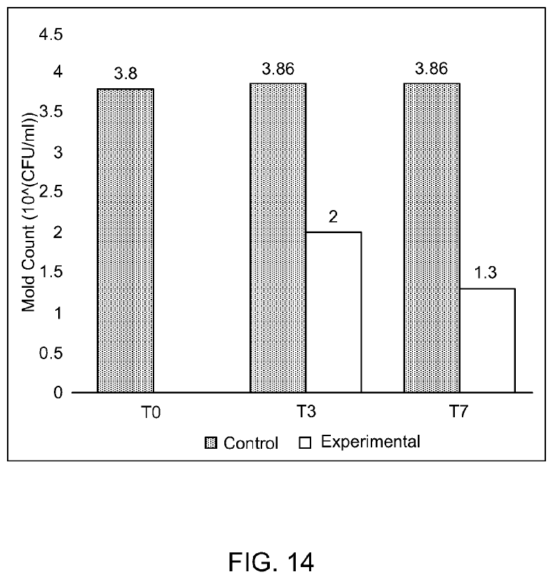

FIG. 14 is a bar graph showing that the sticker was capable of inhibiting mold propagation on the cherry tomatoes from the experimental group, with a 1.9 logs reduction in mold count at T3 and 2.9 logs at T6.

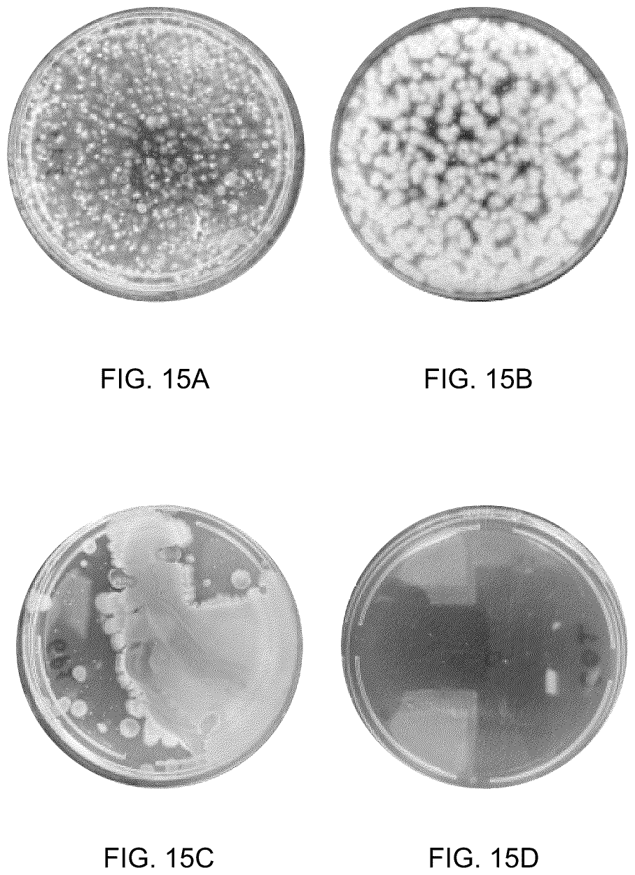

Mold propagation inhibition is more readily seen in FIGS. 15A-15D, when comparing the number of mold colonies obtained from the control group (FIG. 15B) to the limited number of mold colonies obtained from the experimental group (FIG. 15D), from plates of trials identified as Tmt. 3.

These results indicate that the sticker repeatedly inhibited growth of spoilage microorganisms such as molds at prolonged storage at 13° C.

Preliminary testing of isolated colonies using Gram staining and microscopy imaging indicated the presence of Bacillus colonies grown from the nutrient blend.

The results of Tint. 4 are summarized in Table 9.

TABLE 9
Results of 9 days follow up in Trial Tmt. 4:

| | Control group | | | Experimental Group | | |
|---|---|---|---|---|---|---|
| Score # | Box 1 | Box 2 | Box 3 | Box 1 | Box 2 | Box 3 |
| 1 | 1 | 2 | 5 | 2 | 3 | 2 |
| 2 | 10 | 8 | 9 | 4 | 3 | 5 |
| 3 | 19 | 13 | 11 | 17 | 12 | 12 |
| 4 | 10 | 18 | 14 | 19 | 24 | 20 |
| Total | 40 | 41 | 39 | 42 | 42 | 39 |
| % Spoiled | 27.5% | 24.4% | 35.9% | 14.3% | 14.3% | 17.9% |
| Mean | 29.3% (5.9) | | | 15.5% (2.1) | | |
| Spoiled | | | | | | |
| (STDEV) | | | | | | |
| % High | 25.0% | 43.9% | 35.9% | 45.2% | 57.1% | 51% |
| Quality | | | | | | |
| Mean High | 34.9% (9.5) | | | 51.1% (6.0) | | |
| Quality | | | | | | |
| (STDEV) | | | | | | |

It can be concluded from Table 9 that the sticker reduced the % of soilage from 29.3% to 15.5% with a rate by 1.89 fold.

Moreover, the sticker enhanced the overall quality of the cherry tomatoes, evident in the comparison of fruits with a score of 4 (the highest score) between the control and experimental groups. This percentage increased from 34.9% in the control group to 51.1% in the experimental group, representing a 1.5-fold improvement.

### Shelf-Life Extension of Mangoes

The effect of stickers on pathogen colonization and damage of mangoes was also evaluated.

### Materials:

Stickers: According to composition 4 in Table 4
Mangoes—4 units of fresh mangoes from same batch of harvest were bought from a local market.

### Methods:

Experimental Group: two mangoes had a sticker affixed directly onto their outer peel, and subsequently, they were placed inside a polyethylene bag.

Control Group: The rest of the mangoes from same batch were similarly packed without a sticker and served as a control group.

Storage conditions: The storage conditions were 25° C./75% RH all through the study.

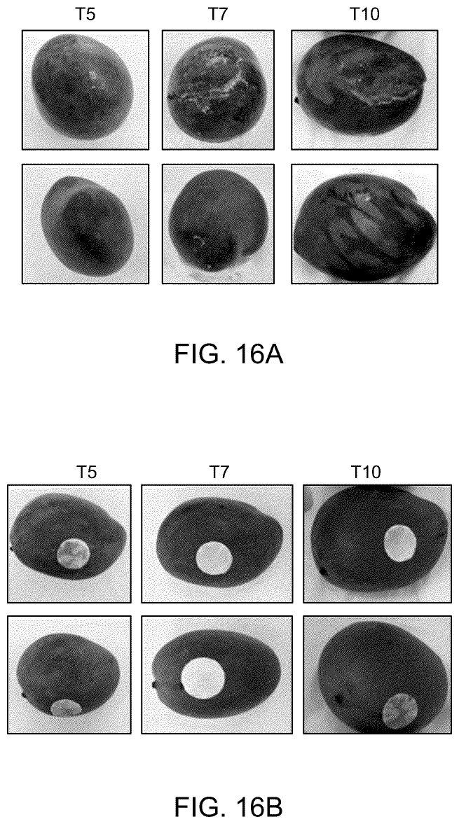

Experimental procedure: The mangoes were visually assessed for color i and signs of decay at 5 (T5), 7 (T7), 10 (T10) days. Photos of the Control group (FIG. 16A) and Experimental group (FIG. 16B) were taken at different time points for documentation (FIGS. 16A-16B).

FIGS. 16A-16B shows that the mangoes of the Control group (FIG. 16A) have started showing signs of discoloration and decay at T5. This phenomenon has worsened at T7 and T10.

1.-62. (canceled)

63. A sticker comprising at least one adhesive component comprising a carrier composition holding a nutrient composition; wherein said carrier composition comprises a food grade binder and said nutrient composition comprises at least one compound suitable for supporting selective growth of one or more human safe bacterium; and wherein said nutrient composition is blended within said carrier composition.

64. The sticker of claim 63, wherein the carrier composition comprises a food grade hygroscopic agent.

65. The sticker of claim 63, wherein said food grade binder comprises at least one polysaccharide or protein or wax.

66. The sticker of claim 63, wherein said at least one food grade binder comprises dextrin, and wherein said dextrin is in an amount of between about 50 wt % and 70 wt % out of a total weight of said adhesive component, preferably between about 55 wt % and 65 wt % out of a total weight of said adhesive component.

67. The sticker of claim 63, wherein said at least one salt is sodium chloride, and wherein said sodium chloride is in an amount of between about 1 wt % and 15 wt % out of a total weight of said adhesive component, preferably between about 2 wt % and 10 wt % out of a total weight of said adhesive component.

68. The sticker of claim 63, wherein said nutrient composition comprises a combination of compounds selected from the group consisting of nitrogen containing compounds, carbohydrates, inorganic minerals, inorganic salts, fatty acids, and vitamins.

69. The sticker of claim 63, wherein said adhesive component has an adhesive component first side and an opposite adhesive component second side.

70. The sticker of claim 69, further comprising a first backing material disposed on the adhesive component first side, said first backing material having a first backing material first side facing the adhesive component and an opposite first backing material second side.

71. The sticker of claim 70, further comprising a first fixation element disposed over said first backing material second side, said first fixation element having a first fixation element first side facing said first backing material and an opposite first fixation element second side configured for fixation of said sticker onto a consumer product.

72. The sticker of claim 71, further comprising a removable first fixation element liner disposed over said first fixation element second side, the removable first fixation element liner being configured to be removed before applying said sticker onto a consumer product.

73. The sticker of claim 69, further comprising a removable adhesive component liner disposed over the adhesive component second side, the removable adhesion component liner being configured to be removed before applying said sticker onto a consumer product.

74. The sticker of claim 70, further comprising a second backing material disposed over the adhesive component second side, said second backing material having a second backing material first side facing the adhesive component and an opposite second backing material second side.

75. The sticker of claim 74, comprising a second fixation element disposed over said second backing material second side, said second fixation element having a second fixation element first side facing said second backing material and an opposite second fixation element second side configured for fixation of said sticker onto a consumer product.

76. The sticker of claim 75, further comprising a removable second fixation element liner disposed over said second fixation element second side, the removable second fixation element liner being configured to be removed before applying said sticker onto a consumer product.

77. A consumer goods package comprising a packaging element holding consumer goods to be preserved and a sticker of claim 63, adhered to said packaging element.

78. The consumer goods package of claim 77, wherein said sticker is adhered onto said packaging element in an internal side of the package.

79. The consumer goods package of claim 77, wherein said sticker is adhered onto said packaging element at an external side of the package having moisture passageway between an inner volume of said package and said adhesive component for activation of said nutrient composition by water vapors.

80. A method for preserving consumer goods, the method comprises adhering to a package holding said consumer goods a sticker according to claim 63, said adhering is in a manner allowing moisture passageway between said consumer goods and said adhesive component.

81. A method for manufacturing a food safe sticker, the method comprises mixing a carrier composition comprising a food grade binder with a nutrient composition comprising at least one compound suitable for supporting selective growth of one or more human safe bacterium to form an adhesive component and shaping said adhesive component.

82. A method for manufacturing a food safe sticker, the method comprises
providing an adhesive component comprising a carrier composition holding a nutrient composition; wherein said carrier composition comprises a food grade binder and said nutrient composition comprises at least one compound suitable for supporting selective growth of one or more human safe bacterium; and
disposing onto at least one side of said adhesive component at least one of a first backing material and a first removable liner and optionally onto an opposite second side of said adhesive component at least one of a second backing material and second removable liner, said first backing material and said second backing material can be the same or different and said first removable liner and said second removable liner can be the same or different.
